(19) United States
(12) Patent Application Publication
(10) Pub. No.: US 2026/0120895 A1
(43) Pub. Date: Apr. 30, 2026

(54) STOCHASTIC MANTLE FOR MAGNETIC FUSION DEVICES AND METHOD OF USE

(71) Applicant: Charles Spencer Pitcher, Toronto (CA)

(72) Inventor: Charles Spencer Pitcher, Toronto (CA)

(21) Appl. No.: 18/956,261

(22) Filed: Nov. 22, 2024

Related U.S. Application Data
(63) Continuation-in-part of application No. 18/562,305, now Pat. No. 12,340,910.
(60) Provisional application No. 63/345,043, filed on May 24, 2022.

(51) Int. Cl. G21B 1/11; G21B 1/05

(52) U.S. Cl. CPC G21B 1/11; G21B 1/057

(57) ABSTRACT

Magnetic nuclear fusion devices face technical challenges related to power and particle control arising from the close proximity of a thermonuclear plasma to the plasma-facing component. The plasma-facing component experiences high incident power density and erosion processes and must facilitate the efficient removal of the fusion-ash. Traditionally, limiters and divertors have been used in magnetic fusion devices for this. These concepts are extended to a new concept, the “stochastic mantle”, which utilizes a stochastic magnetic field layer to disperse power on the plasma-facing component to the maximum extent possible. Further, if operated at sufficient plasma collisionality, it reduces the energy of particles incident on the plasma-facing component, globally reducing erosion by physical sputtering, while producing high gas pressures for fusion-ash removal through pumping ducts. The approach is particularly suited for stellarators, but other devices may be considered.

### CROSS-REFERENCE TO RELATED APPLICATIONS

The instant application is a continuation-in-part of U.S. patent application Ser. No. 18/562,305, filed Nov. 18, 2023, which is a U.S. National Stage application of PCT Application No. PCT/IB2023/000315, filed May 23, 2023, which claims priority to and benefit of U.S. Provisional Application No. 63/345,043, filed May 24, 2022, each of which are incorporated herein by reference in its entirety.

### FIELD OF INVENTION

The present disclosure relates to magnetic nuclear fusion devices. More particularly, the disclosure relates to a mechanism to maximize the dispersal of power incident on the material surfaces that face the thermonuclear plasma, to protect theses surfaces against erosion and to optimize the removal from the vacuum vessel of the waste product particles of the nuclear fusion reaction. Further, the present disclosure relates to a method of using the magnetic nuclear fusion device to form and control a stochastic magnetic field surrounding the core of the magnetic fusion device.

### BACKGROUND OF THE INVENTION

Magnetic fusion devices are designed to confine to the greatest possible extent a hot plasma, typically using a closed toroidal magnetic field geometry. Examples include, tokamaks, spherical tokamaks (STs), stellarators, spheromaks and field-reversed configurations. A toroidal fusion plasma is typically housed within a surrounding plasma chamber, typically a stainless steel vacuum vessel. The vacuum vessel is first evacuated of gas before being filled with fuel gas, typically deuterium and tritium (known as DT), but other fusion fuels may also be considered. The plasma heating turns the gas into plasma and sustains the process against energy losses arising from electromagnetic radiation and cross-field particle transport. The latter arises due to the fact that magnetic confinement of the plasma is not perfect, and the particles and their associated energy gradually leak out to the periphery of the core plasma to a boundary region, eventually impinging on a material surface, i.e. the plasma-facing component, typically designed to protect the stainless steel wall of the vacuum vessel.

Great care must be taken in the design of the boundary region, including the geometry of the magnetic field and the interfacing plasma-facing components. These must work together to ensure that the plasma power exhausted from the core plasma is dispersed as widely as possible in order to limit the peak surface power density. Further, it is desirable to minimize the erosion of the plasma-facing components and to efficiently remove the waste product particles (fusion-ash) created by the fusion reaction (helium-ash in the case of DT fusion). These goals must be achieved without significant degradation of the confining ability of the core plasma. The plasma-surface interaction involving the plasma-facing components has many aspects, most of them deleterious to these structures and the confined plasma, discussed below.

### Plasma-Surface Interactions

With respect to the plasma-facing components, the following may occur: i. the plasma heat flux density may be too large for the surface to handle, even with efficient active cooling, resulting in melting, evaporation and/or cracking of the surface; ii. the particles of the plasma may be of sufficient energy that they may cause physical sputtering of the surface, gradually eroding the surface; iii. the plasma species (typically isotopes of hydrogen) may be chemically reactive with the surface (e.g. in the case of graphite), again resulting in erosion of the surface; iv. energetic ions born in the plasma (e.g. the fusion product ions) may promptly escape the plasma and collide with the plasma-facing components with energies close to their birth energies (i.e. >1 MeV). This tends to happen at specific locations on the plasma-facing components, potentially causing over-heating and surface damage; v. macroscopic uncontrolled movements of the plasma may occur, e.g. disruptions in tokamaks, which may damage plasma-facing components.

In addition to the negative impact on the plasma-facing components, the release of material from the surface into the plasma inevitably suppresses the thermonuclear reaction rate, either by cooling the plasma through radiative processes or by dilution of the fusion reactants in the plasma.

The interaction of the boundary plasma with the plasma-facing component results in the conversion of plasma ions on the material surface by electron recombination into corresponding neutral atoms and molecules (in the case of a hydrogenic plasma). Atom formation may also occur in the volume, typically close to the plasma-facing component by radiative recombination and molecule-assisted recombination. The presence of neutral particles, in particular neutralized fusion-ash particles, provides an opportunity for the removal of the fusion-ash via pumping ducts leading to vacuum pumps, provided sufficiently high gas pressure is generated to make the process efficient.

### Associated Cost of Maintenance

The erosion and general degradation of the plasma-facing components necessitates maintenance, replacement and disposal activities at time intervals typically much shorter than the lifetime of the balance of the fusion power plant.

These are costly activities in many ways, discussed below: i. the fusion device must be designed to allow ready access for robotic maintenance systems (as radiation levels typically preclude human access). Such access can jeopardize the geometry of the magnetic field coils of the fusion device, which otherwise need to be designed to optimize plasma confinement; ii. the robotic systems themselves are large and expensive, but are necessary in order to perform maintenance activities in the hazardous environment inside of the vacuum vessel. They may also fail and therefore themselves need robotic systems to rescue them; iii. the replacement of plasma-facing components by robotic means invariably takes a long time, strongly affecting the availability of the fusion device; iv. the robotic systems and the wasted components need a large support facility away from the fusion device, sometimes called a “Hot Cell”. This is typically as big as the fusion device facility itself; v. the waste components are radioactive waste (radwaste), which must be stored and disposed of with special precautions. The faster the degradation of in-vessel components, the greater the rate of radwaste generation, the greater the disposal costs, and the less time the fusion device is available to operate.

All of the above activities contribute substantially to both the capital cost and operating cost of a fusion power plant and are directly influenced by the lifetime of the plasma-facing components.

### Types of Plasma-Facing Components

Over many decades of magnetic fusion research, a number of different types of plasma-facing components have been used with varying success to receive the plasma power, to minimize the erosion rate and to provide for the removal of the fusion-ash. These are summarized below.

### i. Limiters

This was the first type of approach commonly used for plasma-facing components and had application to most types of magnetic fusion devices. The limiter is attached to the vacuum vessel and protrudes beyond other plasma-facing components into the plasma to ensure that it represents the point of first contact for the plasma, see FIGS. 1, corresponding to the last closed flux surface (LCFS) of the nested closed magnetic flux surfaces 14 that provide the plasma confinement. As it receives a high heat flux, it is typically constructed from a refractory material, e.g. tungsten or nuclear-grade graphite, and may be passively or actively-cooled, depending on the duration of the plasma operation.

Limiters 61 are effective at taking the brunt of the particle power coming out of the plasma and providing protection for the remaining plasma-facing components, and have been effective at widely dispersing power, provided large areas are utilized for receiving the power, as indicated in FIG. 1B. However, limiters have not been effective at minimizing the erosion rate of its surface, nor for the efficient removal of the fusion-ash.

### ii. Divertors

Although proposed very early in the history of fusion research, the divertor approach was only used commonly after the limiter approach, representing a general improvement in performance over the limiter approach (see Ref. 1). In this case, the magnetic geometry of the plasma boundary is configured to “divert” the magnetic field, and therefore the boundary plasma, to a location somewhat removed from the core plasma (see FIG. 1C). By doing so, it is possible to reduce the energy of particles impinging on the divertor plate 72 surface, thus reducing erosion by physical sputtering, and to make it more difficult for any released material to enter the core plasma. The divertor magnetic field geometry, however, tends to focus the exhausted plasma power to localized points on the divertor plate 72, i.e. divertor strike points 73, which makes heat removal challenging at these locations.

The divertor has the advantage of enhancing the gas density arising from the neutralization of the plasma at the divertor plate, including the density of the fusion-ash. A divertor baffle, 71A and 71B, is typically employed around the divertor plate to prevent the escape of gas, enhancing the gas pressure, making it an efficient location to put a pumping duct and to apply gas pumping to remove the fusion-ash from the vacuum chamber. The divertor plate and baffle, however, constrain the location of the pumping duct, its associated nuclear shielding (if any), the plasma shape and the plasma positioning.

### iii. First-Wall and Blanket

While the limiter and divertor approaches define the boundary of the plasma, there is still a significant fraction of the fusion power and particles which may impinge on the remaining plasma-facing components arising from the following: i. the prompt escape of energetic fusion products particles (neutrons and ions); ii. plasma that may diffuse rapidly across the magnetic field lines; iii. neutral hydrogenic particles, which may cross field lines through charge-exchange processes; iv. electromagnetic radiation emanating from the plasma.

These power and particle fluxes necessitate additional protection of the wall with specially designed plasma-facing components. In the case of the neutrons, as these are energetic enough to pass through thin structures, including the vacuum vessel, protection is also needed for the magnetic coils, the balance of the plant and the facility operators. Approximately 1.0 m of actively-cooled shielding is required—the “blanket” 15 (see FIG. 1C). The blanket is capable of stopping the neutrons and removing the associated power. It also serves as a location to breed tritium from lithium in the case of DT fusion.

With respect to the balance of the power flux to the wall, an actively-cooled structure is required to remove the power incident on the surface of the blanket, i.e. the “first-wall” 61 (see FIG. 1C). While the power flux density is well below of that experienced at limiters and divertors (at least under normal operating conditions), the first-wall 61 is still subjected to the bombardment of ions and atoms leaving the plasma, resulting in erosion processes, normally dominated by physical sputtering.

### iv. Plasma-Facing Components—Summary of Issues

While the divertor approach has historically improved many aspects of the limiter approach (see Ref. 1), residual problems remain, including: i. exhausted power tends to be focused at a relatively small fraction of the material surfaces facing the plasma (at divertor strike points), challenging the power removal technology of the divertor plate and limiting its lifetime; ii. surface degradation of plasma-facing components still occurs at most locations around the periphery of the plasma, including both the divertor and the first-wall, due to incident particle bombardment, primarily due to physical sputtering, limiting their lifetime; iii. fusion-ash gas can only be removed at specific locations which require specialized hardware (i.e. divertor plates and divertor baffles), highly constraining the location of pumping ducts, the associated nuclear shielding (if any), the plasma shape and the plasma positioning.

### v. A Better Solution—the Stochastic Mantle

In this application, a solution is identified that solves the residual problems of the divertor approach arising from the power dispersal and the erosion of the placing-facing components, and that further improves the fusion-ash removal. The solution is the “stochastic mantle” concept. Although, it is particularly suited for the stellarator approach to magnetic fusion, described below, it need not be limited to this type of device and may find application to other forms of magnetic fusion devices.

A first objective of the present invention is to disperse the power leaving the core plasma to the widest possible extent. This ensures that the power is as uniformly incident on the plasma-facing components to the greatest possible extent. This reduces the peak power density in the fusion device, ensuring that the peak power density is as close as possible to the average power density. This eases the engineering of the active heat-removal design, invariably reducing its cost, increasing reliability and lifetime.

A second objective of the invention is to reduce, and even eliminate, the erosion by physical sputtering of all plasma-facing components by reducing the energy of incident ions and atoms at all locations. This increases the lifetime of the plasma-facing components, decreases the generation of retired components that become radwaste, and increases the availability of the fusion device, which altogether decreases the operating cost of the fusion power plant.

A third objective is to enhance and simplify the removal of the fusion-ash gas from the vacuum vessel by increasing the gas pressure at the plasma-facing components in the vicinity of pumping ducts and by removing the requirement for localized divertor baffling. The former allowing the use of smaller pumping ducts and vacuum pumps, thus easing nuclear shielding requirements, thus reducing capital costs. The latter giving freedom and flexibility with respect to the location of the pumping ducts, the associated nuclear shielding, the plasma shape and the plasma positioning. While some of the objectives of the present invention are disclosed in the prior art, none of the inventions found address all of the objectives identified.

### vi. Definitions

The following are relevant definitions:
i. engineering limits for power removal—The engineering of power removal surfaces requires the respect of material limits for temperature, mechanical stress, thermal conductivity, and coolant medium physical properties;
ii. thermonuclear plasma conditions—conditions within the plasma having sufficient density and temperature that thermonuclear reactions occur;
iii. poloidal direction—In a toroidal plasma, a direction that is orthogonal to both the radial and toroidal directions (see FIG. 1A);
iv. charge-exchange processes—A process by which an atom or a molecule exchanges an electron with a plasma ion, whereby the plasma ion becomes a neutral atom and is no longer confined by the magnetic field;
v. physical sputtering—A process by which ions and atoms incident on the plasma-facing component have sufficient energy to liberate surface atoms from the surface by physical collisions;
vi. parallel electron heat conduction—Conduction of plasma heat along magnetic field lines in the parallel-field direction by plasma electrons, owing to the presence of a temperature gradient, with conduction from the high temperature location to the low temperature location;
vii. atomic radiative process—Processes involving the collisional excitation of bound electrons in atoms by the free electrons in the mantle plasma;
viii. molecular radiative process—Processes involving the collisional excitation of bound electrons in molecules by the free electrons in the mantle plasma;
ix. recombination processes—Processes that result in the neutralization of plasma ions caused by recombination with an electron, either occurring on the surface of the plasma-facing component with an electron supplied by the surface, or in the volume by recombination with a plasma electron. There are several types of volume recombination, including radiative recombination and molecule assisted recombination; and
x. molecule formation process—Processes that result in the formation of molecules from its constituent atoms, typically occurring on the surface of the plasma-facing component.

### SUMMARY

A stellarator fusion reactor satisfying the objectives identified above can be constructed from the following components. A core plasma is provided. The core plasma is configured by a core magnetic geometry. The core magnetic geometry includes nested, closed, three-dimensional toroidal magnetic flux surfaces. The core magnetic geometry is created by a combination of external magnets and internal electric currents flowing within the core plasma. The core magnetic geometry confines the core plasma against energy losses by particle and thermal transport across and along magnetic field lines. This confinement allows attainment of thermonuclear plasma conditions, resulting in nuclear fusion reactivity and generating energetic fusion product particles. The energetic fusion product particles include neutrons and ions.

A surrounding plasma chamber is provided. The surrounding plasma chamber has an interior plasma-facing component. The interior plasma-facing component is actively-cooled in order to receive power leaving the core plasma, while maintaining the interior plasma-facing component within engineering limits for power removal. A stochastic mantle is provided. The stochastic mantle is located outside of the core magnetic geometry and has a stochastic magnetic field. The stochastic magnetic field has magnetic fields lines circumnavigating the stellarator fusion reactor, moving in a toroidal direction, diffusing randomly in both a radial direction and a poloidal direction (see FIG. 1A) such that a portion of the magnetic fields lines intersect the internal plasma-facing component of the surrounding plasma chamber.

A mantle plasma is provided. The mantle plasma is present in the stochastic mantle. The mantle plasma includes ions, electrons, atoms and molecules. A fusion-ash is created. The fusion-ash includes particles created as energetic fusion ions, after the energetic fusion ions lose energy and reach a temperature of local conditions in the core plasma and the mantle plasma. A conducted power is created. The conducted power is created in the core plasma and moves to a periphery of the core plasma. The stochastic mantle conveys the conducted power to the interior plasma-facing component along the stochastic magnetic field by particle and thermal transport.

The stochastic magnetic field is configured with the combination of external magnets and internal electric currents flowing within the core plasma to provide uniform deposition of the conducted power on a surface of the interior plasma-facing component.

In an embodiment of the disclosure, the stochastic mantle further includes a last closed flux surface (LCFS). The LCFS marks an outermost flux surface of the core magnetic geometry.

The LCFS provides a boundary between the core plasma and the mantle plasma. The stochastic magnetic field ensures that parallel plasma transport processes in the mantle plasma result in similar plasma transport processes in the radial direction. The mantle plasma is subject to power transport processes, including heat conduction, convection and electromagnetic radiation.

A connection length L is provided. The connection length L is a distance from a location within the stochastic mantle along the stochastic magnetic field which intersects the interior plasma-facing component. The connection length L is a maximum for field lines originating adjacent the LCFS. The mantle plasma has a high collisionality. The high collisionality arises from an electron mean free path along field lines shorter than the connection length L from the LCFS throughout the stochastic mantle.

In another variant, the stochastic mantle further includes an opaque condition within the mantle plasma. The opaque condition ensures that the atoms and the molecules entering the stochastic mantle adjacent the interior plasma-facing component are screened by ionization processes within the mantle plasma before reaching the LCFS. The opaque condition within the stochastic mantle ensures that the conducted power coming from the core plasma enters the stochastic mantle by conduction.

The opaque condition within the stochastic mantle, prevents creation of energetic atoms by charge-exchange processes inside the LCFS, preventing energy loss by the energetic atoms from the core plasma and eliminating the potential for physical sputtering by the energetic atoms of the interior plasma-facing component.

In still another embodiment, the stochastic mantle further includes a conduction-limited layer. The conduction-limited layer transmits power by parallel electron heat conduction. The stochastic magnetic field ensures that the parallel electron heat conduction results in radial electron heat conduction. The conduction-limited layer is located adjacent to the LCFS and extends radially outward into the stochastic mantle. The conduction-limited layer results from high plasma collisionality and an absence of convection resulting from the opaque plasma condition. The conduction-limited layer supports a first mantle plasma temperature adjacent the LCFS and a second, lower mantle plasma temperature adjacent the interior plasma-facing component.

The second lower mantle plasma temperature adjacent to the interior plasma-facing component ensures lower particle energies for particles striking the interior plasma-facing component. The low particle energies reduce physical sputtering, thereby reducing erosion of the interior plasma-facing component. A mantle plasma pressure is created. The mantle plasma pressure is created within the stochastic mantle and is a product of a mantle plasma density and the second, lower mantle plasma temperature, wherein the plasma density sums all particle types in the plasma. The conduction-limited layer and the absence of convection ensures that the mantle plasma pressure is conserved along the stochastic magnetic field in the conduction-limited layer. A radial decrease in the second, lower plasma temperature results in a radial rise in the mantle plasma density within the conduction-limited layer.

In still another embodiment, the stochastic mantle further includes a dissipative layer. The dissipative layer includes the atoms and the molecules. Interaction between the mantle plasma and the atoms and the molecules results in dissipative processes. The dissipative layer is located in a region of the second, lower mantle plasma temperature outside of the conduction-limited layer and adjacent to the interior plasma-facing component as a result of the opaque condition. The dissipative processes within the dissipative layer include ionization of the atoms and the molecules, dissociation of the molecules, an atomic radiative process, molecular radiative processes, bremsstrahlung radiation from the electrons in the mantle plasma, recombination processes and a molecule formation process. The dissipative processes occur in a volume of the dissipative layer and adjacent to the surface of the interior plasma-facing component. The fusion-ash is present in the mantle plasma. The fusion-ash becomes the fusion-ash gas by the recombination processes.

The dissipative processes reduce the second, lower mantle plasma temperature in the dissipative layer adjacent the interior plasma-facing component. This reduced second, lower mantle plasma temperature ensures lower particle energies for particles striking the interior plasma-facing component. The lower particle energies reduce the physical sputtering, thereby reducing erosion of the interior plasma-facing component. A gas pressure is created. The gas pressure within the dissipative layer, adjacent the plasma-facing component, is a sum of a pressure of the atoms, a pressure of the molecules and a pressure of the fusion-ash gas. The dissipative layer increases the gas pressure adjacent the interior plasma-facing component to facilitate removal of gas and the fusion-ash gas through pumping ducts exiting the surrounding plasma chamber through vacuum pumps. The gas and fusion-ash gas surrounding the periphery of the core plasma, allow placement of the pumping ducts around the periphery of the core plasma.

Aside from stellarators, a toroidal magnetic fusion device employing the stochastic mantle technology can be constructed from the following components. A toroidal fusion plasma that has a toroidal fusion core plasma is provided. The toroidal fusion core plasma is created by a combination of external magnets and internal electric currents flowing within the toroidal fusion core plasma. The toroidal fusion core plasma has energy losses by particle and thermal transport across and along magnetic field lines, the energy losses carrying power to a periphery of the toroidal fusion core plasma. The magnetic fusion device has a surrounding plasma chamber. The surrounding plasma chamber has an interior plasma-facing component. The interior plasma-facing component is actively-cooled in order to receive the power, while maintaining the interior plasma-facing component within engineering limits for power removal.

A stochastic mantle is provided. The stochastic mantle includes mantle plasma and is located outside of the toroidal fusion core plasma. The stochastic mantle has a stochastic magnetic field, the stochastic magnetic field has magnetic fields lines that circumnavigate the toroidal fusion plasma. The magnetic field lines move in a toroidal direction and diffuse in both radial and poloidal directions. A first portion of the magnetic field lines intersect the internal plasma-facing component of the surrounding plasma chamber. The stochastic mantle allows energy losses from the toroidal fusion core plasma to the interior plasma-facing component along the magnetic field lines by particle and thermal transport.

The stochastic mantle is generated without degrading confinement of the toroidal fusion core plasma. The stochastic mantle is configured with the magnetic field lines providing a flux of particles, plasma momentum and energy along the magnetic field lines corresponding to radial flux based on the stochastic magnetic field. The first portion of the magnetic field lines that intersect with the interior plasma-facing component is configured with the combination of external magnets and internal electric currents flowing within the toroidal fusion core plasma to provide uniform deposition of the power incident on a surface of the interior plasma-facing component. The stochastic mantle separates the toroidal fusion core plasma from the interior plasma-facing component. The stochastic mantle has a first radial width and high collisionality. The first radial width and the high collisionality permit development of parallel-field plasma temperature gradients and dissipative processes. The parallel-field plasma temperature gradients and dissipative processes provide cold plasma conditions adjacent the interior plasma-facing component.

The cold plasma conditions adjacent to the interior plasma-facing component provide low particle energies for the particles striking the interior plasma-facing component. The low particle energies reduce physical sputtering, thereby reducing erosion of the interior plasma-facing component. The dissipative processes within the stochastic mantle include plasma-neutral interactions with neutral particles. The plasma-neutral interactions elevate gas pressure adjacent the interior plasma-facing component to facilitate removal of fusion-ash gas through pumping ducts connected to vacuum pumps. The gas pressure and fusion-ash gas surround the periphery of the toroidal fusion core plasma to permit placement of the pumping ducts around the periphery of the core plasma.

The stochastic mantle includes an inner, conduction-limited layer and an outer, dissipative layer. The inner conduction-limited layer transmits power by parallel electron heat conduction. The outer, dissipative layer, where the atoms and the molecules are present provides dissipative processes by an interaction of the mantle plasma with the atoms and the molecules.

The stochastic mantle protects the interior plasma-facing component of the magnetic fusion device as the stochastic mantle is global and uniform.

In a further embodiment of the disclosure, the stellarator fusion reactor further includes an energetic fusion product ion loss process. The energetic fusion product ion loss process arises from a portion of energetic fusion product ions not transferring energy to the core plasma. This portion of the energetic fusion product ions escape the core plasma and reach the periphery of the core plasma. The stochastic mantle provides protection of the interior plasma-facing component against the energetic fusion product ion loss process. The protection provided by the mantle plasma, includes the atoms and the molecules which reduce the energy of the energetic fusion product ions exiting from the core plasma through a friction process, globally protecting the interior plasma-facing components from excessive local incident power density and damage.

In another aspect, a magnetic fusion system comprises a vacuum vessel having an interior plasma-facing component, a core plasma positioned within the vacuum vessel, a mantle plasma positioned within the vacuum vessel and forming a mantle around the core plasma, such that the mantle plasma is between the core plasma and the plasma-facing component, and a plurality of external magnets contributing to the formation of a confining magnetic field and a stochastic magnetic field, wherein the confining magnetic field comprises a last closed flux surface LCFS surrounding the core plasma, wherein the stochastic magnetic field surrounds the confining magnetic field, and wherein the mantle plasma is positioned within the stochastic magnetic field.

In some embodiments, the system further comprises a blanket surrounding at least a portion of the vacuum vessel, wherein the blanket comprises at least one of a tritium breeder and a nuclear radiation shield, a vacuum pump disposed external to the blanket, and a magnetic fusion system penetration comprising a pumping duct that extends from the vacuum pump, through the blanket, to the plasma-facing component of the vacuum vessel, wherein one or more magnetic fusion system penetration installation locations are not selected based on a diverter plate or a diverter baffle location.

In some embodiments, the mantle plasma further comprises a conduction limited portion with a density profile corresponding to a radial temperature gradient and plasma pressure that is conserved along the stochastic magnetic field in the conduction limited portion, and a dissipative portion with a gas pressure corresponding to a second lower plasma temperature, arising from the radial temperature gradient, wherein the conduction limited portion is between the last closed flux surface and the dissipative portion, and wherein the dissipative portion is between the plasma facing components and the conduction limited portion.

In some embodiments, a density profile comprises a radial rise in density of the mantle plasma in the conduction limited portion as temperature of the mantle plasma in the conduction limited portion decreases in the radial direction and plasma pressure is conserved along the stochastic magnetic field in the conduction-limited portion.

In some embodiments, the system further comprises a gas layer between the mantle plasma and the plasma facing component of the vacuum vessel, wherein a gas pressure in the gas layer increases as the mantle plasma temperature decreases in the dissipative portion.

In some embodiments, a temperature of the mantle plasma is lower in the dissipative portion relative to a temperature of the conduction limited portion.

In some embodiments, the stochastic magnetic field is configured to increase collisionality of the mantle plasma.

In some embodiments, the stochastic magnetic field is configured to approximately uniformly disperse power from the core plasma to the plasma facing component.

In some embodiments, the core plasma is at a first higher temperature and the mantle plasma is at a second lower temperature.

In some embodiments, the plasma facing component is actively cooled.

In some embodiments, the mantle plasma is in opaque condition.

In another aspect, a method of generating power from a nuclear fusion reaction, comprises providing a magnetic fusion system comprising a fusion chamber including interior plasma facing components, and a plurality of magnets surrounding the exterior of the fusion chamber, releasing a fuel gas within the fusion chamber, heating the fuel gas, generating a toroidal magnetic field having a last closed flux surface (LCFS) and a stochastic magnetic field from the plurality of magnets, accounting for electrical currents flowing within the plasma, generating a core plasma within the fusion chamber from the heated fusion gas confined within the LCFS by the magnetic field, generating a stochastic mantle plasma within the fusion chamber from the heated fusion gas external to the LCFS by the stochastic magnetic field, wherein the mantle plasma surrounds the core plasma within the fusion chamber, and receiving power from the core plasma and dispersing it widely over the plasma facing components.

In some embodiments the stochastic mantle plasma comprises a detached condition comprising at least one of a high collisionality condition, an opaque condition, a conduction limited heat transport condition, and one or more dissipative processes.

In some embodiments the one or more dissipative processes comprises one or more of ionization of particles, dissociation of molecules, molecular radiative processes, bremsstrahlung radiation, charge exchange, and recombination.

In some embodiments erosion of the plasma facing components is reduced or eliminated due to the detached condition of the stochastic mantle plasma reducing or eliminating physical sputtering producing by incident particles interacting with the plasma facing components.

In some embodiments the erosion of the plasma-facing components is reduced by at least at least 90% due to the low plasma temperature adjacent to the plasma facing components.

In some embodiments the stochastic mantle plasma comprises a conduction limited portion positioned outside and proximate to the LCFS, wherein at least one of the high collisionality condition, the opaque condition, and the conduction limited heat transport condition are present.

In some embodiments the stochastic mantle plasma comprises a dissipative portion positioned between the conduction limited portion and the plasma facing components, wherein the one or more dissipative processes are present.

In some embodiments the method further comprises generating electrical power by utilizing the captured power from the core plasma to operate a turbine system.

In some embodiments the captured power is uniformly dispersed over the plasma facing components.

In some embodiments the magnetic fusion system comprises a stellarator reactor or other forms of closed toroidal magnetic field geometry, e.g. tokamaks, spherical tokamaks (STs), spheromaks and field-reversed configurations.

In another aspect, a method of forming a plasma having a stochastic mantle in a magnetic fusion system comprises providing the magnetic fusion system comprising a fusion chamber including an interior plasma facing component, and a plurality of magnets surrounding the exterior of the fusion chamber, evacuating the fusion chamber via a vacuum system fluidly connected to the fusion chamber, releasing a fusion gas within the fusion chamber, heating the fusion gas within the fusion chamber to a plasma state, generating via the plurality of magnets while accounting for internal plasma magnetic fields cause by currents within the plasma a magnetic field having a core confinement portion and a mantle portion, wherein the core confinement portion includes a last closed flux surface (LCFS), and wherein the mantle portion is stochastic and surrounds the core confinement portion within the fusion chamber, and confining a first portion of the plasma within the core confinement portion and exhausting plasma power in a second portion of the plasma within the mantle stochastic portion, such that the LCFS is between the first plasma portion and the second plasma portion.

In some embodiments the method further comprises tuning plasma density of the plasma via at least one of an addition of fusion gas and a removal of exhausted gas through pumping ducts exiting the surrounding plasma chamber through vacuum pumps, wherein the exhausted gas includes waste gas in the form of helium ash atoms.

In some embodiments the core confinement portion comprises a toroidal magnetic field and a poloidal magnetic field.

In some embodiments the magnets that surround the plasma chamber comprise one or more of an electromagnet, a permanent magnet, or a diamagnet, wherein the magnets comprise one or more of helical coils, non-planar coils, planar coils, toroidal coils, perturbation coils, or resonant magnetic perturbation coils, and wherein the heating system comprises one or more of a microwave heater, a neutral particle beam heater, an ion cyclotron resonance heater, or an electron cyclotron resonance heater.

In some embodiments the plasma conditions at the last closed flux surface (LCFS) range with a plasma density between 3×10¹⁹ m⁻³ to 5×10²⁰ m⁻³ and a plasma temperature in the range of 30 eV to 1000 eV.

In some embodiments the plasma conditions at the plasma facing component range with a plasma temperature between 0.1 eV to 30 eV.

In another aspect, a magnetic fusion system comprises a toroidal vacuum vessel having an interior plasma-facing component, surrounded by a plurality of external magnets, a core plasma positioned within the vacuum vessel about a central portion in a toroidal direction, and a stochastic mantle plasma positioned between the core plasma and the plasma-facing component.

In some embodiments the system further comprises a breeder blanket position between the interior plasma facing component and an interior wall of the vacuum vessel.

In some embodiments the system further comprises a plurality of gas ports passing through the breeder blanket, fluidly connecting the interior of the vacuum vessel to a gas control system.

In some embodiments the system further comprises a heating system comprising one or more of a resistive heating method, a neutral particle beam heater, an ion cyclotron resonance heater, and an electron cyclotron resonance heater.

In some embodiments the magnets comprise one or more of an electromagnet, a permanent magnet, and a diamagnet, wherein the electromagnets comprise one or more of helical coils, non-planar coils, and/or planar coils.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements.

FIG. 1A is a cross-sectional view of a generic toroidal magnetic fusion device.

FIG. 1B is a schematic of a generic toroidal magnetic fusion device utilizing a limiter.

FIG. 1C is a schematic of a generic toroidal magnetic fusion device utilizing a divertor assembly.

FIG. 2 is a cross-section view of one embodiment of the present disclosure in a generic toroidal magnetic fusion device.

FIG. 3 is a cross-section view of one embodiment of the present disclosure in a stellarator fusion reactor.

FIG. 4 is a graph illustrating the radial dependencies of plasma conditions in and near the stochastic mantle in one embodiment of the present disclosure in a stellarator fusion reactor.

FIG. 5 is a cross-section view of one embodiment of the present disclosure in operation.

FIG. 6 is a graph illustrating the radial dependencies of plasma conditions in one embodiment of the present disclosure.

FIG. 7A is a top view of a generic magnetic fusion device with a laminar magnetic field.

FIG. 7B is a top view of a generic magnetic fusion device with a stochastic magnetic field.

FIG. 8 is a schematic demonstration of a cross-sectional cut along an exemplary stellarator fusion reactor.

FIG. 9 is a plot-point graph depicting the relationship between vacuum field and finite-β equilibrium.

FIG. 10 is a cross-sectional view of a generic magnetic fusion reactor utilizing divertor assemblies.

FIG. 11 is a close-up schematic of one example of a divertor assembly.

FIG. 12A is a cross-sectional view of an embodiment of the stochastic mantle of the present disclosure.

FIG. 12B is a close-up view of an embodiment of the stochastic mantle of the present disclosure.

FIGS. 13A-13E are schematic representations of exemplary stellarator magnetic fusion devices with main magnets.

FIGS. 14A-14C are schematic representations of exemplary stellarator magnetic fusion devices with control magnets.

FIG. 15A is a physical representation of one aspect of an exemplary first-wall panel.

FIG. 15B is a schematic representation of an exemplary actively cooled component portion of an embodiment of a first-wall panel.

FIG. 16 is a flow chart depicting a method of use embodiment of the present disclosure.

FIG. 17 is a flow chart depicting an embodiment of a method of using the present disclosure.

### DETAILED DESCRIPTION

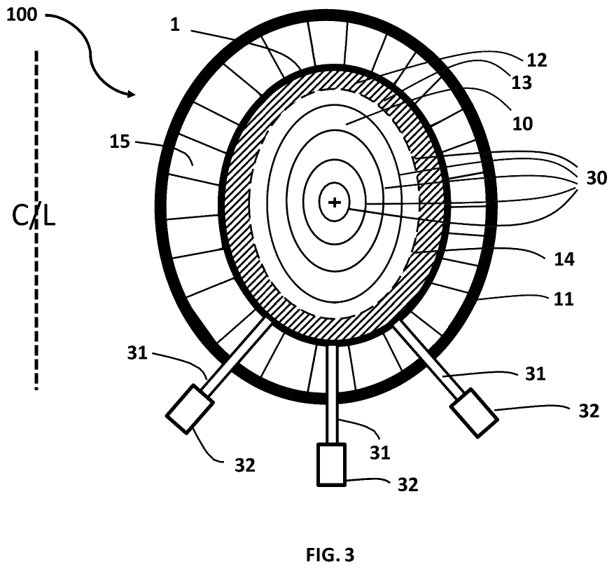

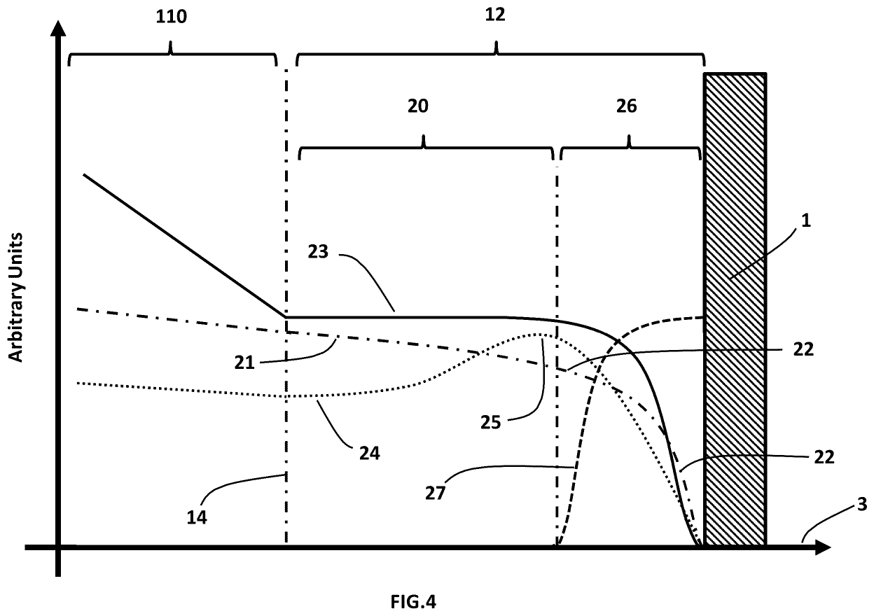

As illustrated in FIGS. 3-4, a stellarator fusion reactor 100 satisfying the objectives identified above can be constructed from the following components. A core plasma 10 is provided. The core plasma 10 is configured by a core magnetic geometry. The core magnetic geometry includes nested, closed, three-dimensional toroidal magnetic flux surfaces 30 as shown in FIG. 3. The core magnetic geometry is created by a combination of external magnets and internal electric currents flowing within the core plasma 10. The core magnetic geometry confines the core plasma 10 against energy losses by particle and thermal transport across and along magnetic field lines. This confinement allows attainment of thermonuclear plasma conditions, resulting in nuclear fusion reactivity and generating energetic fusion product particles. The energetic fusion product particles include neutrons and ions in the case of DT fusion.

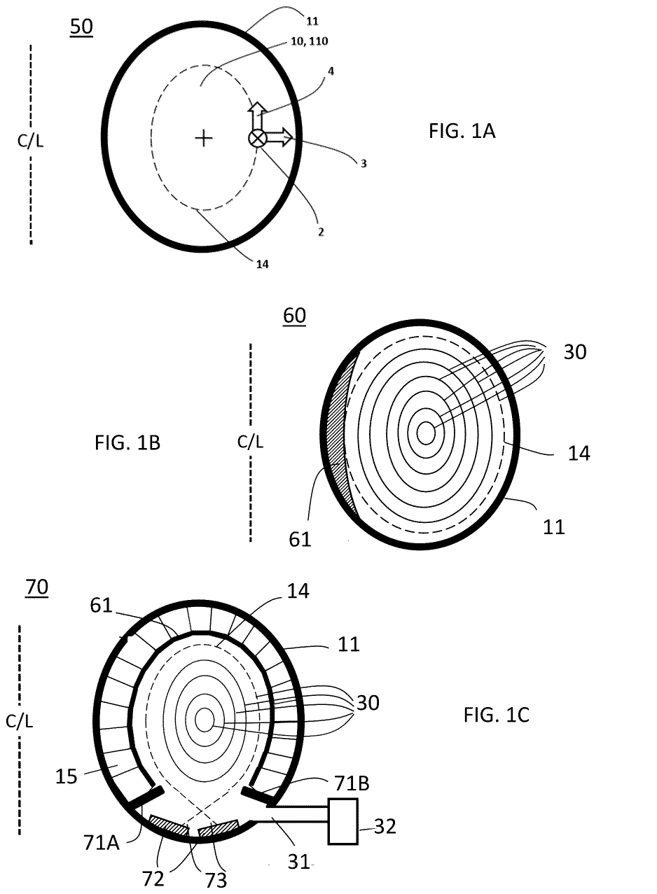

A surrounding plasma chamber 11 is provided. The surrounding plasma chamber 11 has an interior plasma-facing component 1. The interior plasma-facing component 1 is actively-cooled in order to receive power leaving the core plasma 10, while maintaining the interior plasma-facing component 1 within engineering limits for power removal. A stochastic mantle 12 is provided. The stochastic mantle 12 is located outside of the core magnetic geometry and has a stochastic magnetic field. The stochastic magnetic field has magnetic fields lines circumnavigating the stellarator fusion reactor 100, moving in a toroidal direction 2, diffusing randomly in both a radial direction 3 and a poloidal direction 4, as illustrated in FIG. 1A. A portion of the magnetic field lines intersect the internal plasma-facing component 1 of the surrounding plasma chamber 11.

A mantle plasma 13 is provided. The mantle plasma 13 is present in the stochastic mantle 12. The mantle plasma 13 includes ions, electrons, atoms and molecules. A fusion-ash is created. The fusion-ash includes particles created as energetic fusion ions, after the energetic fusion ions lose energy and reach a temperature of local conditions in the core plasma 10 and the mantle plasma 13. A conducted power is created. The conducted power is created in the core plasma 10 and moves to a periphery of the core plasma 10. The stochastic mantle 12 conveys the conducted power to the interior plasma-facing component 1 along the stochastic magnetic field by particle and thermal transport. The stochastic magnetic field is configured with the combination of external magnets and internal electric currents flowing within the core plasma 10 to provide uniform deposition of the conducted power on a surface of the interior plasma-facing component.

In a variant of the disclosure, the stochastic mantle 12 further includes a last closed flux surface (LCFS) 14. The LCFS 14 marks an outer most flux surface of the core magnetic geometry. The LCFS 14 provides a boundary between the core plasma 10 and the mantle plasma 13. The stochastic magnetic field ensures that parallel plasma transport processes in the mantle plasma 13 result in similar plasma transport processes in the radial direction 3. The mantle plasma 13 is subject to power transport processes, including heat conduction, convection and electromagnetic radiation.

A connection length L is provided. The connection length L is a distance from a location within the stochastic mantle 12 along the stochastic magnetic field which intersects the interior plasma-facing component 1. The connection length L is a maximum for field lines originating adjacent the LCFS 14. The mantle plasma 13 has a high collisionality. The high collisionality arises from an electron mean free path along field lines shorter than the connection length L from the LCFS throughout the stochastic mantle 12.

In another variant, the stochastic mantle 12 further includes an opaque condition within the mantle plasma 13. The opaque condition ensures that the atoms and the molecules entering the stochastic mantle 12 adjacent the interior plasma-facing component 1 are screened by ionization processes within the mantle plasma 13 before reaching the LCFS 14. The opaque condition within the stochastic mantle 12 ensures that the conducted power coming from the core plasma 10 enters the stochastic mantle 12 by conduction.

The opaque condition within the stochastic mantle 12, prevents creation of energetic atoms by charge-exchange processes inside the LCFS 14, preventing energy loss by the energetic atoms from the core plasma 10 and eliminating potential for physical sputtering by the energetic atoms of the interior plasma-facing component 1.

In still another variant, as illustrated in FIGS. 3 and 4, the stochastic mantle 12 further includes a conduction-limited layer 20. The conduction-limited layer 20 transmits power by parallel electron heat conduction. The stochastic magnetic field ensures that the parallel electron heat conduction results in radial electron heat conduction. The conduction-limited layer 20 is located adjacent to the LCFS 14 and extends radially outward into the stochastic mantle 12. The conduction-limited layer 20 results from high plasma collisionality and an absence of convection resulting from the opaque plasma condition. The conduction-limited layer 20 supports a first mantle plasma temperature 21 adjacent the LCFS 14 and a second, lower mantle plasma temperature 22 adjacent the interior plasma-facing component 1.

The second lower mantle plasma temperature 22 adjacent to the interior plasma-facing component 1 ensures lower particle energies for particles striking the interior plasma-facing component 1. The low particle energies reduce physical sputtering, thereby reducing erosion of the interior plasma-facing component 1. A mantle plasma pressure 23 is created. The mantle plasma pressure 23 is created within the stochastic mantle 12 and is a product of a mantle plasma density 24 and the second, lower mantle plasma temperature 22 where the plasma density sums all particle types in the plasma. The conduction-limited layer 20 and the absence of convection ensures that the mantle plasma pressure 23 is conserved along the stochastic magnetic field in the conduction-limited layer 20. A radial decrease in the second, lower plasma temperature 22 results in a radial rise 25 in the mantle plasma density 24 within the conduction-limited layer 20.

In still another variant, the stochastic mantle 12 further includes a dissipative layer 26. The dissipative layer 26 includes the atoms and the molecules. Interaction between the mantle plasma 13 and the atoms and the molecules results in dissipative processes. The dissipative layer 26 is located in a region of the second, lower mantle plasma temperature 22 outside of the conduction-limited layer 20 and adjacent the interior plasma-facing component 1 as a result of the opaque condition.

The dissipative processes within the dissipative layer 26 include ionization of the atoms and the molecules, dissociation of the molecules, an atomic radiative process, molecular radiative processes, bremsstrahlung radiation from the electrons in the mantle plasma 13, recombination processes and a molecule formation process. The dissipative processes occur in a volume of the dissipative layer 26 and adjacent to the surface of the interior plasma-facing component 1. The fusion-ash is present in the mantle plasma 13. The fusion-ash becomes the fusion-ash gas by the recombination processes.

The dissipative processes reduce the second, lower mantle plasma temperature 22 in the dissipative layer 26 adjacent the interior plasma-facing component 1. This reduced second, lower mantle plasma temperature 22 ensuring lower particle energies for particles striking the interior plasma-facing component 1. The lower particle energies reduce the physical sputtering, thereby reducing erosion of the interior plasma-facing component 1. A gas pressure 27 is created. The gas pressure 27 within the dissipative layer 26, adjacent the plasma-facing component 1, is a sum of a pressure of the atoms, a pressure of the molecules and a pressure of the fusion-ash gas. The dissipative layer 26 increases the gas pressure 27 adjacent the interior plasma-facing component 1 to facilitate removal of gas and the fusion-ash gas through pumping ducts 31 exiting the surrounding plasma chamber 11 through vacuum pumps 32. The gas and fusion-ash gas surrounding the periphery of the core plasma 10, allow placement of the pumping ducts 31 around the periphery of the core plasma 10.

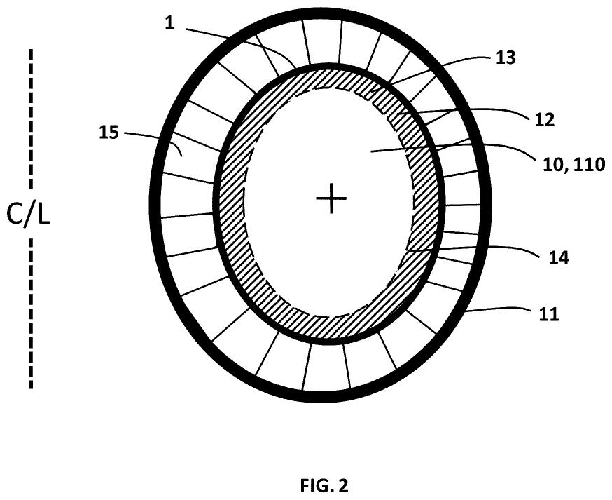

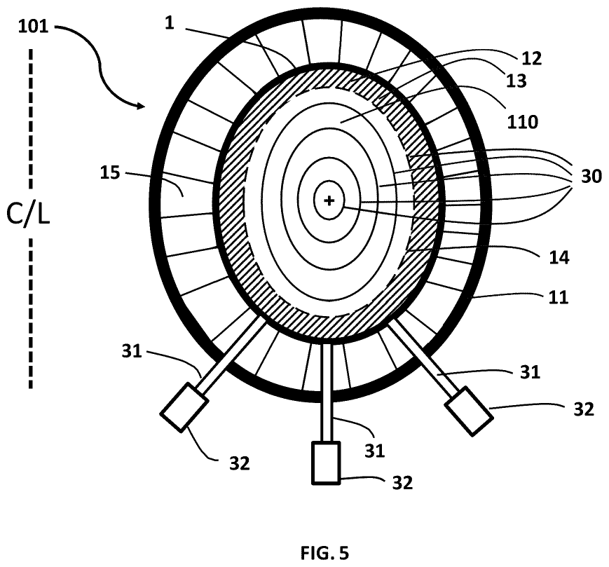

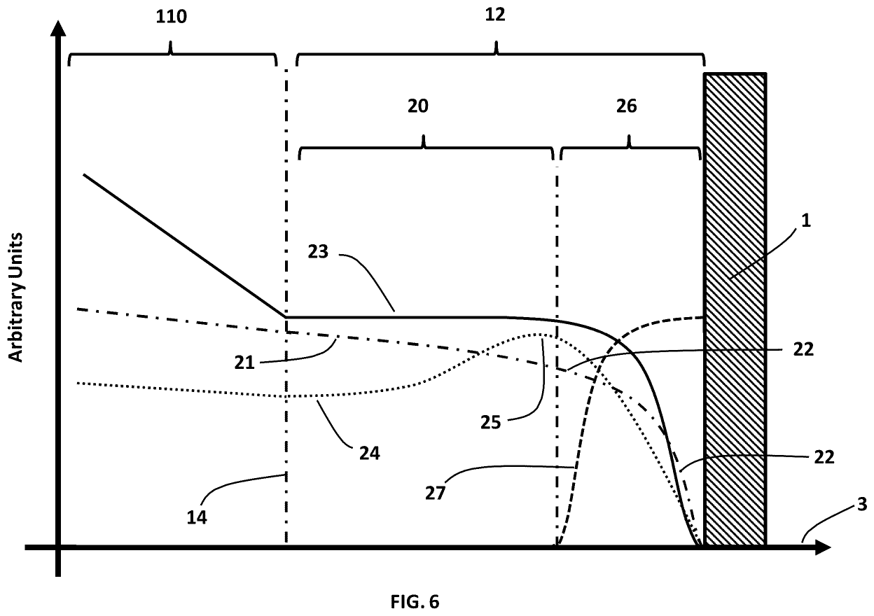

As illustrated in FIGS. 1A, 1B, 1C, 2, 5 and 6, aside from stellarators, a toroidal magnetic fusion device 101 employing the stochastic mantle 12 technology can be constructed from the following components. A toroidal fusion plasma that has a toroidal fusion core plasma 110 is provided. The toroidal fusion core plasma 110 is created by a combination of external magnets and internal electric currents flowing within the toroidal fusion core plasma 110. The toroidal fusion core plasma 110 has energy losses by particle and thermal transport across and along magnetic field lines, the energy losses carrying power to a periphery of the toroidal fusion core plasma 110. The magnetic fusion device has a surrounding plasma chamber 11. The surrounding plasma chamber 11 has an interior plasma-facing component 1. The interior plasma-facing component 1 is actively-cooled in order to receive the power, while maintaining the interior plasma-facing component 1 within engineering limits for power removal.

A stochastic mantle 12 is provided. The stochastic mantle 12 includes mantle plasma 13 and is located outside of the toroidal fusion core plasma 110. The stochastic mantle 12 has a stochastic magnetic field. The stochastic magnetic field has magnetic fields lines that circumnavigate the toroidal fusion core plasma 110. The magnetic field lines move in a toroidal direction 2 and diffuse in radial 3 and poloidal 4 directions. A first portion of the magnetic field lines intersect the interior plasma-facing component 1 of the surrounding plasma chamber 11. The stochastic mantle 12 allows energy losses from the toroidal fusion core plasma 110 to the interior plasma-facing component 1 along the magnetic field lines by particle and thermal transport.

The stochastic mantle 12 is generated without degrading confinement of the toroidal fusion core plasma 110. The stochastic mantle 12 is configured with the magnetic field lines providing a flux of particles, plasma momentum and energy along the magnetic field lines corresponding to radial flux based on the stochastic magnetic field. The first portion of the magnetic field lines that intersects with the interior plasma-facing component 1 is configured with the combination of external magnets and internal electric currents flowing within the toroidal fusion core plasma 110 to provide uniform deposition of the power incident on a surface of the interior plasma-facing component 1. The stochastic mantle 12 separates the toroidal fusion core plasma 110 from the interior plasma-facing component 1. The stochastic mantle 12 has a first radial width and high collisionality. The first radial width and the high collisionality permit development of parallel-field plasma temperature gradients and dissipative processes.

The parallel-field plasma temperature gradients and dissipative processes provide cold plasma conditions adjacent the interior plasma-facing component 1. The cold plasma conditions adjacent to the interior plasma-facing component 1 provide low particle energies for the particles striking the interior plasma-facing component 1. The low particle energies reduce physical sputtering, thereby reducing erosion of the interior plasma-facing component 1. The dissipative processes within the stochastic mantle include plasma-neutral interactions with neutral particles. The plasma-neutral interactions elevate gas pressure 27 adjacent the interior plasma-facing component 1 to facilitate removal of fusion-ash gas through pumping ducts 31 connected to vacuum pumps 32. The gas pressure 27 and fusion-ash gas surround the periphery of the toroidal fusion core plasma 110 permit placement of the pumping ducts 31 around the periphery of the toroidal fusion core plasma 110.

The stochastic mantle 12 includes an inner, conduction-limited layer 20 and an outer, dissipative layer 26. The inner conduction-limited layer 20 transmits power by parallel electron heat conduction. The outer, dissipative layer 26, where atoms and molecules are present provides dissipative processes by an interaction of the mantle plasma 13 with the atoms and the molecules. The stochastic mantle 12 protects the interior plasma-facing component 1 of the magnetic fusion device, as the stochastic mantle 12 is global and uniform.

In a further variant of the invention, as illustrated in FIGS. 3-4, the stellarator fusion reactor 100 further includes an energetic fusion product ion loss process. The energetic fusion product ion loss process arises from a portion of energetic fusion product ions not transferring energy to the core plasma 10. This portion of the energetic fusion product ions escape the core plasma 10 and reach the periphery of the core plasma 10. The stochastic mantle 12 provides protection of the interior plasma-facing component 1 against the energetic fusion product ion loss process. The protection provided by the mantle plasma 13, includes the atoms and the molecules which reduce energy of the energetic fusion product ions exiting from the core plasma 10 through a friction process, globally protecting the interior plasma-facing component 1 from excessive local incident power density and damage.

In another variant of the invention, as illustrated in FIGS. 1, 2, 5 and 6, aside from stellarators, a toroidal the magnetic fusion device 101 further includes an energetic fusion product ion loss process. The energetic fusion product ion loss process arises from a portion of energetic fusion product ions not transferring energy to the toroidal fusion core plasma 110. This portion of the energetic fusion product ions escape the toroidal fusion core plasma 110 and reach the periphery of the toroidal fusion core plasma 110. The stochastic mantle 12 provides protection of the interior plasma-facing component 1 against the energetic fusion product ion loss process. The protection provided by the mantle plasma 13, includes the atoms and the molecules which reduce energy of the energetic fusion product ions exiting from the toroidal fusion core plasma 110 through a friction process, globally protecting the interior plasma-facing components 1 from excessive local incident power density and damage.

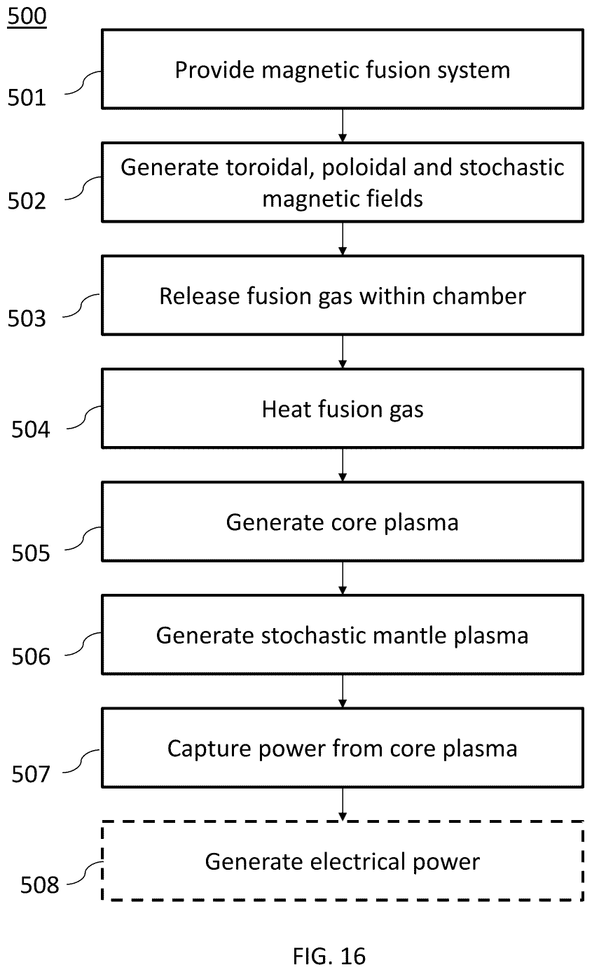

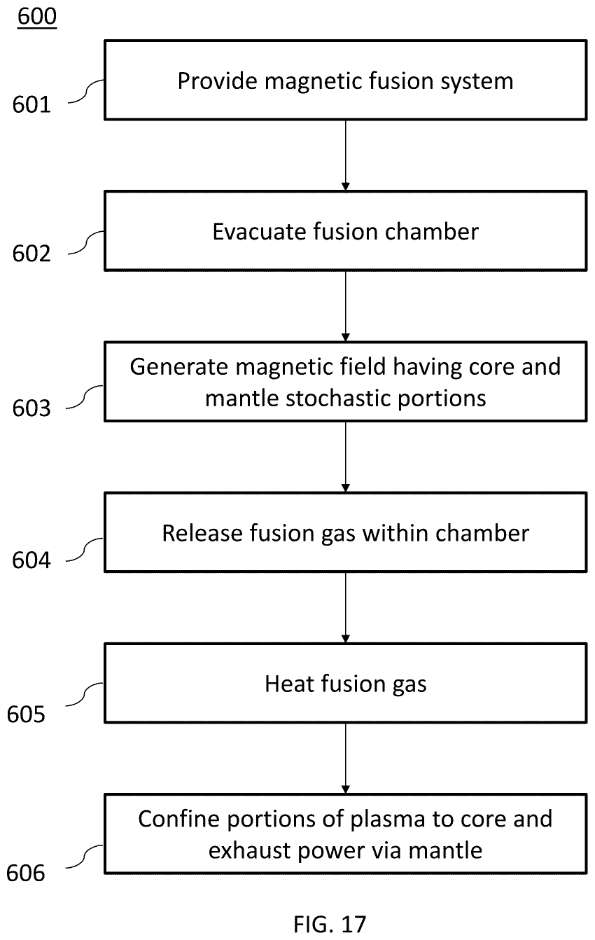

Related methods are further disclosed below and in FIGS. 16-17. As shown in FIG. 16, a method 500 of generating power from a nuclear fusion reaction begins at Step 501 where a magnetic fusion system comprising a fusion chamber including interior plasma facing components and a plurality of magnets surrounding the exterior of the fusion chamber is provided. In some embodiments the magnetic fusion system comprises a stellarator reactor or another form of toroidal magnetic fusion reactor.

At Step 502 the toroidal and poloidal magnetic field having a last closed flux surface (LCFS) and a stochastic magnetic field are generated via the plurality of magnets.

At Step 503 a fusion gas is released within the fusion chamber.

At Step 504 the fusion gas is heated.

At Step 505 a core plasma is generated within the fusion chamber from the heated fusion gas confined within the LCFS by the toroidal and poloidal magnetic field.

At Step 506 a stochastic mantle plasma is generated within the fusion chamber external to the LCFS in the region of stochastic magnetic field, wherein the mantle plasma surrounds the core plasma within the fusion chamber. In some embodiments the stochastic mantle plasma comprises a detached condition comprising at least one of a high collisionality condition, an opaque condition, a conduction limited heat transport condition, and one or more dissipative processes. In some embodiments the one or more dissipative processes comprises one or more of ionization of neutral particles, dissociation of molecules, molecular radiative processes, bremsstrahlung radiation, charge exchange, and recombination.

In some embodiments erosion of the plasma facing components is reduced or eliminated due to the detached condition of the stochastic mantle plasma reducing or eliminating sputtering producing incident particles interacting with the plasma facing components. In some embodiments the erosion of the plasma-facing components is reduced by at least 90%.

In some embodiments the stochastic mantle plasma comprises a conduction limited portion positioned proximate to the LCFS, wherein at least one of the high collisionality condition, the opaque condition, and the conduction limited heat transport condition are present. In some embodiments the stochastic mantle plasma comprises a dissipative portion positioned between the conduction limited portion and the plasma facing components, wherein the one or more dissipative processes are present.

At Step 507 power released from the fusion reaction in from the core plasma is dispersed widely over the plasma facing components and absorbed in the blanket and is captured. In some embodiments the captured power is uniformly dispersed over the plasma facing components and blanket.

At optional Step 508 electrical power is generated by utilizing the captured power from the core plasma to operate a turbine system. In another embodiment, captured power from the core plasma is converted into heat for industrial processes.

In another aspect a method 600 of forming a plasma having a stochastic mantle in a magnetic fusion system begins at Step 601 where the magnetic fusion system comprising a fusion chamber including an interior plasma facing component, and a plurality of magnets surrounding the exterior of the fusion chamber is provided.

At Step 602 the fusion chamber is evacuated of atmospheric gas via a vacuum system fluidly connected to the fusion chamber.

Step 603 comprises generating, via the plurality of magnets while accounting for internal plasma magnetic fields caused by currents within the plasma, a magnetic field having a core confinement portion and a mantle stochastic portion, wherein the core confinement portion includes a last closed flux surface (LCFS), and wherein the mantle portion is stochastic and surrounds the core confinement portion within the fusion chamber. In some embodiments the core confinement portion comprises a toroidal and poloidal magnetic field. In some embodiments the magnets comprise one or more of an electromagnet, a permanent magnet, or a diamagnet, wherein the electromagnets comprise one or more of helical coils, non-planar coils and planar coils.

At Step 604 a fusion gas is released within the fusion chamber.

At Step 605 the fusion gas is heated within the fusion chamber to a become plasma via a heating system. In some embodiments, the heating system comprises one or more of a resistive heating method, a neutral particle beam heater, an ion cyclotron resonance heater, and an electron cyclotron resonance heater.

Step 606 comprises confining a first portion of the plasma within the core confinement portion and exhausting plasma power via a second portion of the plasma within the mantle stochastic portion, such that the LCFS is between the first plasma portion and the second plasma portion.

In some embodiments the method 600 further comprises tuning plasma density of the plasma via at least one of an addition of fusion gas into the plasma chamber and/or a removal of exhausted gas through pumping ducts exiting the surrounding plasma chamber through vacuum pumps, wherein the exhausted gas includes waste gas in the form of helium ash atoms.

In some embodiments the plasma conditions at the last closed flux surface (LCFS) range with a plasma density between 3×10¹⁹ m⁻³ to 5×10²⁰ m⁻³ and a plasma temperature in the range of 30 eV to 1000 eV.

In some embodiments the plasma conditions at the plasma facing component range with a plasma temperature between 0.1 eV to 30 eV.

### Scientific Principles and Experimental Findings

### Laminar Magnetic Field Vs Stochastic Magnetic Field

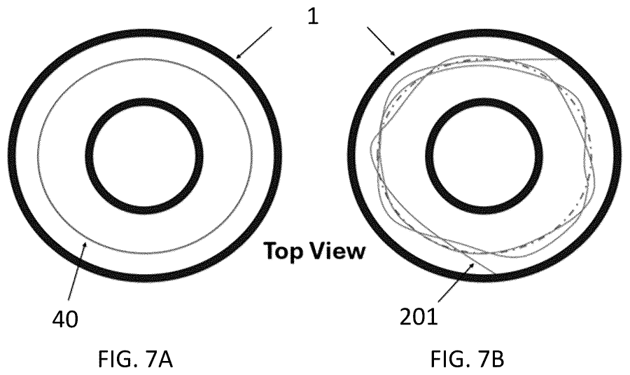

The basis of magnetic confinement of plasma is derived from the fact that charged particles (ions and electrons) spiral around the magnetic field line and do not traversing it (to first order). Charged particles are free, however, to travel along the magnetic field line. Therefore, to ensure confinement of the particles, i.e. to avoid the particles escaping along the magnetic field, toroidal magnetic fusion devices close the field upon itself, as depicted in FIG. 7A. This is sometimes referred to as a laminar magnetic field structure 40.

Depending on the magnetic coil geometry and the currents flowing in the plasma, the magnetic field lines can break down, becoming “braided”, or “stochastic”. The stochastic magnetic field line 201 is displaced randomly in transverse directions as the field line wraps around the device in the toroidal direction, as depicted in FIG. 7B. Such field structure is unsuited to confining plasma, particularly if the field line intersects the plasma-facing component 1 (i.e. the wall), as indicated in FIG. 7B. The stochastic field 201 structure, however, which is a key feature in this Application, can be useful in exhausting the power and particles from the plasma.

### Stochastic Magnetic Field in Stellarators

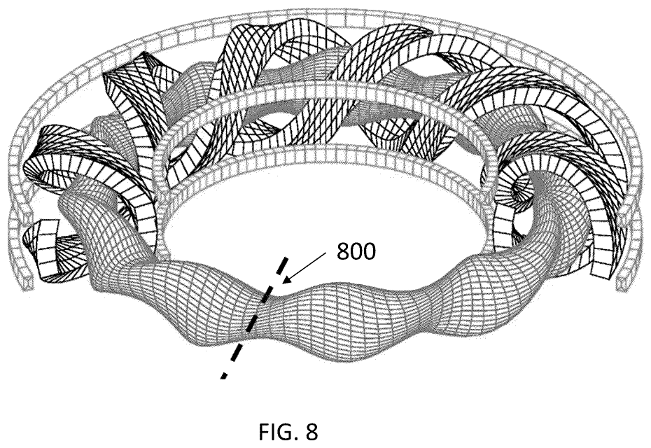

The first key phenomenon comes from the well-known and well-understood observation of stochastic magnetic field structure in the periphery of stellarator plasmas (see Refs. 2-13). Stellarators are toroidal magnetic fusion devices, see FIG. 8, which shows the Large Helical Device (LHD), a stellarator in Japan, as an example.

A stochastic magnetic field arises in the periphery of the plasma from a combination of the fields generated by external magnets and by the electrical currents flowing within the plasma. The electrical currents arise due to a variety of plasma processes, many of which increase in magnitude as the plasma pressure is increased. The external magnets allow a degree of control and permit optimization.

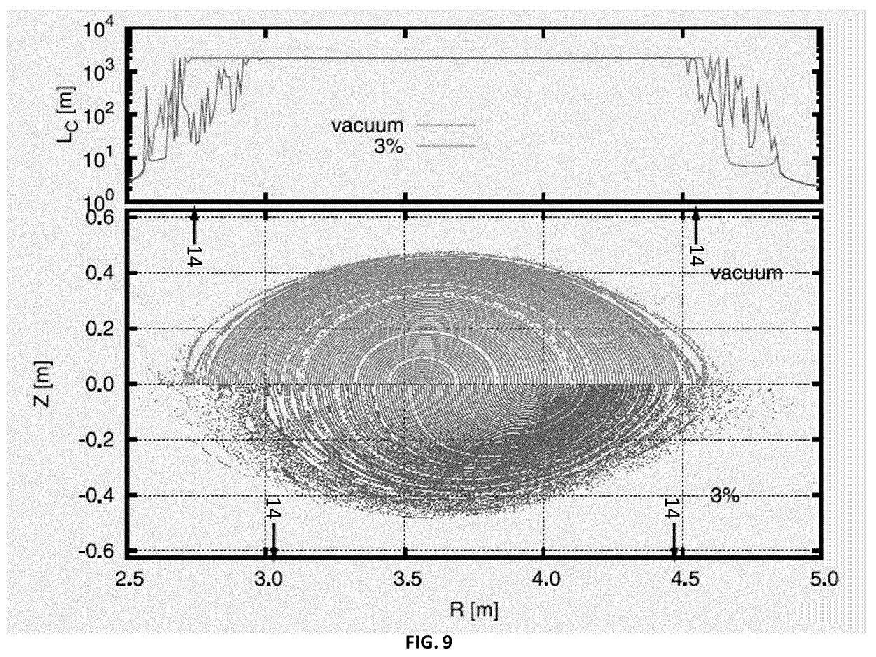

FIG. 9 demonstrates an example of stochastic magnetic field in LHD. This figure shows the poloidal cross-section through the plasma (located, as indicated in FIG. 8). FIG. 9 is a Poincare plot, also known as a puncture plot, which gives the position of the magnetic field line as it crosses (or punctures through) the defined poloidal cross-section cut (as indicated in FIG. 8). FIG. 9 gives in the top half, (1) only the vacuum magnetic field (i.e. without plasma, generated by the external coils only) and in the bottom half, (2) including the plasma with a normalized plasma pressure R=3% (P is the ratio of plasma pressure to magnetic pressure). In both cases, (1) and (2), the plasma core comprises laminar, nested (i.e. closed) magnetic flux surfaces.

One will note that even in the case of the vacuum magnetic field, the boundary region is somewhat stochastic. In the presence of plasma, three-dimensional currents that flow in the plasma (that arise due to radial plasma pressure gradients) enhance the stochastic magnetic field structure in the boundary.

FIG. 9 also gives the connection length denoted Lc (but denoted L in the present Application). This is the distance along a magnetic field line wrapped around the LHD device in the toroidal direction, starting at one location on the wall, and ending at another location on the wall (see FIGS. 7A and 7B for example). One can see that the distance Lc along field lines can be substantial in the stochastic region, i.e. hundreds of meters, and this region expands at higher plasma pressure, or higher.

FIG. 9 also indicates with arrows the location of the Last Closed Flux Surface (LCFS) 14—the radial location that marks the separation between magnetic field which closes on itself, forming closed nested flux surfaces (L is infinite), and magnetic field, which is open, connecting to a material surface with a finite connection length L.

The presence of a stochastic magnetic field in the boundary is a necessary condition for the Stochastic Mantle approach.

### Detached Divertor Approach

The second phenomenon is the Detached Divertor approach, a mode of operation in the boundary of tokamaks and stellarators, whereby cold plasma and high gas pressures, both an operational advantage, can be induced adjacent to material surfaces at the boundary of the plasma. The Detached Divertor approach was developed in the 1990's and is now well-established and understood (see Refs. 1, 14-25).

This mode of operation can be induced in the periphery in both tokamaks and stellarators, is now considered the standard and conventional means of handling the power and particles in tokamaks and stellarators. It is described in more detail below, including its necessary conditions.

### Divertors

In DT fusion, 20% of the power that is liberated by the fusion reaction is released in the form of an energetic alpha particle that deposits this power in the plasma. This power then crosses the closed magnetic flux surfaces until it reaches the LCFS and then the plasma boundary—a region where field lines connect directly with the plasma-facing components.

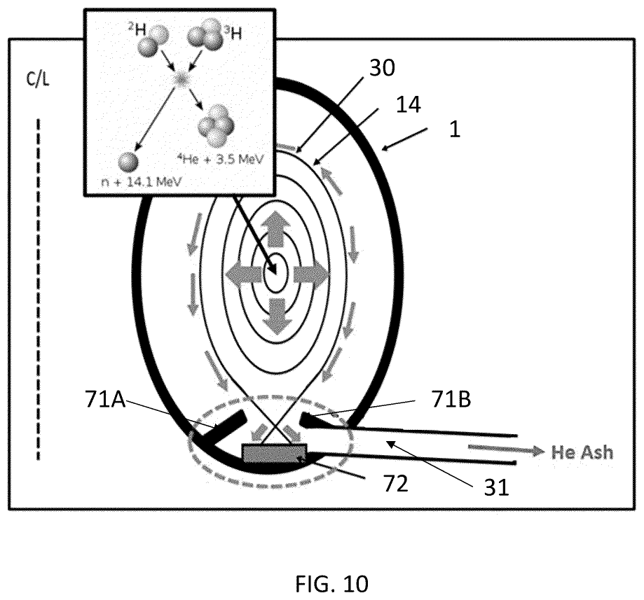

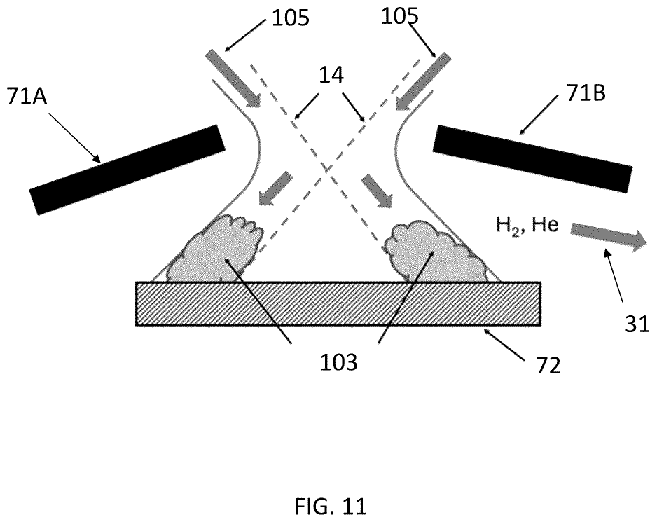

In the past, in both tokamaks and stellarators, the magnetic structure 30 in the boundary outside of the LCFS 14 was intentionally configured to focus the power onto a structure known as the divertor plate 72, see FIG. 10, and a closeup view of the divertor region in FIG. 11. One notes the presence of closed magnetic flux surfaces 30 inside the LCFS 14 and laminar magnetic field 40 everywhere.

This geometry allows the development of low plasma temperature, high plasma density and high gas pressure in the vicinity of the divertor plate. These conditions are advantageous for the reduction of erosion at the target plate and the removal of the helium ash (in gaseous form) through a pumping duct. Typically, a divertor baffle 71A, 71B is used to help contain the gas in the vicinity of the pumping duct.

### Necessary Conditions for Detached Divertor Operation

With reference to FIG. 10 and FIG. 11, the necessary conditions required for detached divertor operation are listed and discussed below (see Ref 1):
High Collisionality—The plasma in the boundary must be of sufficient collisionality so that the electron mean free path along field lines 30 is shorter than the connection length L, the distance along a field line between two material surfaces (i.e. the divertor plate 72). This condition is required for the development of temperature gradients between the LCFS 14 away from the divertor and the divertor plate 72, based on finite electron thermal heat conduction along magnetic field lines.
Opaque Condition—The plasma in the divertor region must be opaque for the atoms and molecules in the vicinity of the divertor plate 72 to ensure that heat transport from the LCFS 14 to the divertor plate is by thermal conduction 105 and not by convection, thus ensuring that a temperature gradient may be created. The atoms and molecules are prevented from reaching far from the divertor plate 72 by ionization processes in the divertor plasma.
Conduction Limited Heat Transport—The high collisionality and the opaque plasma conditions ensure that heat flow from the LCFS 14 away from the divertor to the divertor plate 72 is by conduction and not by convection, thus allowing the development of gradients along field lines and low plasma temperature adjacent to the divertor plate 72, while maintaining a higher plasma temperature at the LCFS 14. The low plasma temperature adjacent to the divertor plate 72 ensures that incident particle energies are low, reducing the rate of physical sputtering.
iv. Dissipative Processes—The contact of the plasma (i.e. the impingement of plasma ions, including helium ash) with the divertor plate 72 generates neutral particles (atoms and molecules), due to the ions that recombine to become atoms and the atoms that recombine to become molecules. This creates a gas pressure close to the divertor plate 72. The gas interacts with the plasma leading to several dissipative processes 103 including ionization of atoms and molecules, dissociation of molecules, and molecular radiative processes, bremsstrahlung radiation, charge-exchange and recombination. These processes 103 decrease the plasma temperature further (reducing erosion by physical sputtering) and enhance the gas pressure (enhancing the removal of fuel and helium fusion-ash gas through pumping ducts), with the divertor baffles (71A and 71B) helping to enhance the gas pressure at the entrance of the pumping duct 31.

All these processes (105 and 107) and their beneficial effects have been studied theoretically, experimentally investigated and verified. This body of R&D represented a major advancement in fusion energy science and technology at the time (1990's).

### Detached Divertor Issues

Despite the advantages of the Detached Divertor approach over previous approaches, there are three issues which have remained unresolved for nearly 30 years. These are:

Focusing of Exhaust Power—Exhausted power tends to be focused on a relatively small fraction of the plasma-facing components (i.e. the divertor plate), challenging the power removal technology of the divertor plate and limiting its lifetime.

Global Erosion—Surface degradation of plasma-facing components still occurs at most locations around the periphery of the plasma, including both the divertor and the remaining plasma-facing components, due to incident particle bombardment resulting in physical sputtering reducing their lifetime, primarily by energy atoms which are not confined by magnetic field.

Inconvenient Gas Removal—Fuel and helium ash gas can only be removed at specific locations which require specialized hardware (i.e. divertor plates and divertor baffles), highly constraining the location of pumping ducts, the associated nuclear shielding (if any), the plasma shape and the plasma positioning.

### Stochastic Field+Detachment: A Novel Combination

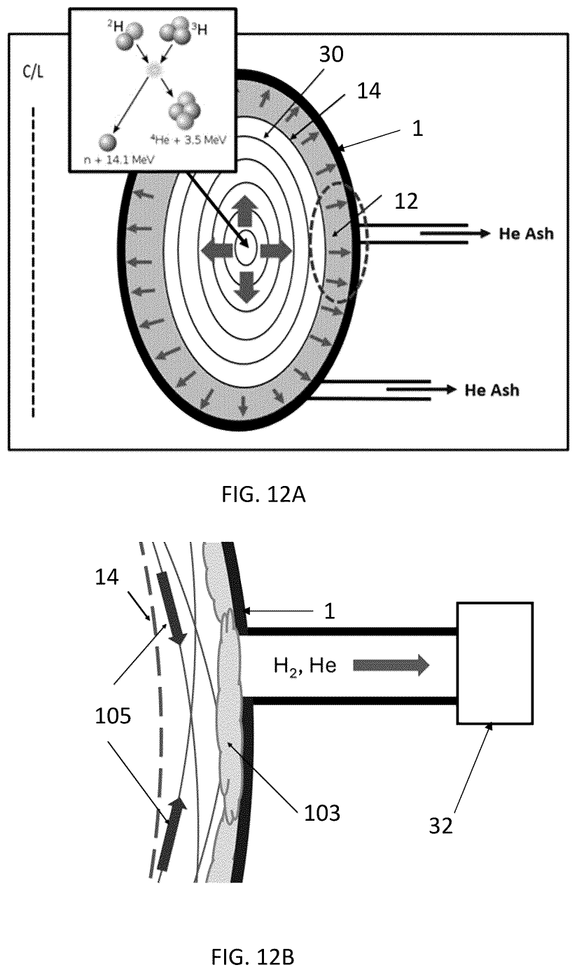

The above three issues may be resolved by using a novel combination of stochastic magnetic field in the boundary of stellarators and other toroidal magnetic fusion reactors with plasma detachment, illustrated in FIGS. 12A and 12B, and discussed below. The novel approach is known as the “Stochastic Mantle”, as the entire core plasma is enveloped by a mantle of low temperature plasma and high gas pressure—an attractive interface between the confined thermonuclear plasma and the material structures of the device.

Stochastic Mantle—This novel approach requires several necessary conditions, discussed already above in the context of stochastic magnet field 201 in stellarators and detached divertors in tokamaks and stellarators. To summarize, the following are required:
Stochastic Field Structure in the Boundary—A stochastic magnetic field 201 structure that is produced using a combination of external magnets and electrical currents flowing in the plasma that is configured to spread power coming from the plasma to the plasma facing components 1. This will widely distribute power that crosses the LCFS 14 from the confined plasma onto the wall rather than focusing it at one specific location, as in the case of a conventional divertor. In both cases, power is carried along magnetic field lines to a material surface.
Detachment Requirements—This is the same set of requirements as in the case of the conventional detached divertor approach, except in a different magnetic geometry outside of the LCFS 14, as illustrated in FIG. 12B. The following conditions are required for detachment: i. High Collisionality; ii. Opaque Condition; iii. Conduction Limited Heat Transport; and iv. Dissipative Processes

It is to be noted that the physics of plasma detachment primarily depends on the transport of plasma heat, atomic and molecular physics, and is generally well understood and can be observed in many different physical problems in science and technology with many different magnetic field geometries, and even in the absence of magnetic field. The detachment requirements listed here should be readily achieved by the stochastic magnetic field geometry, envisaged plasma conditions and the plasma-facing component 1 geometry indicated in FIG. 12B.

### Advantages of the Stochastic Mantle

The Stochastic Mantle approach to power and particle handling resolves the remaining issues facing the conventional divertor approach.

Maximal Spreading of Exhaust Power—The Stochastic Mantle approach spreads the plasma power crossing the LCFS 14 to the greatest possible degree, making use of all the surfaces facing the plasma for power and particle handling. This ultimately will enable fusion devices based on this approach to operate with an overall higher power density.

Global Erosion Protection—As detached conditions are maintained at all locations facing the plasma, the entire plasma-facing component 1 is protected against incident particles (ions and atoms) that may cause physical sputtering. A substantial increase in wall lifetime is expected.

Convenient Gas Removal—The Stochastic Mantle approach generates high gas pressure everywhere around the periphery of the plasma, allowing pumping ducts 31 to be placed wherever convenient, obviating the need for divertor plates 72, divertor baffles (71A and 71B) and giving flexibility on plasma shape and positioning within the plasma chamber 11, as well as giving flexibility to physical tolerances for installing the pumping ducts.

Stellarators confine plasmas using a three-dimensional toroidal magnetic field configuration. The magnetic field is generated primarily by external magnets which can have many different configurations but are optimized by computer simulations in order to confine both the thermal plasma and the high energy charged particles (for example, alpha particles in deuterium-tritium fusion). There are two types of magnets used to form the magnetic field:
I. Main electromagnets 107, which are large and link the toroidal plasma, and provide most of the magnetic field in the toroidal direction. They provide the majority of the magnetic field, but may also contribute to the three dimensional shaping of the plasma, including the poloidal field and the stochastic field in the boundary.
II. Control magnets 109, which are smaller and typically do not link the toroidal plasma, and provide finer control on the shape of the plasma and the stochastic field in the boundary (see Refs. 26-36).

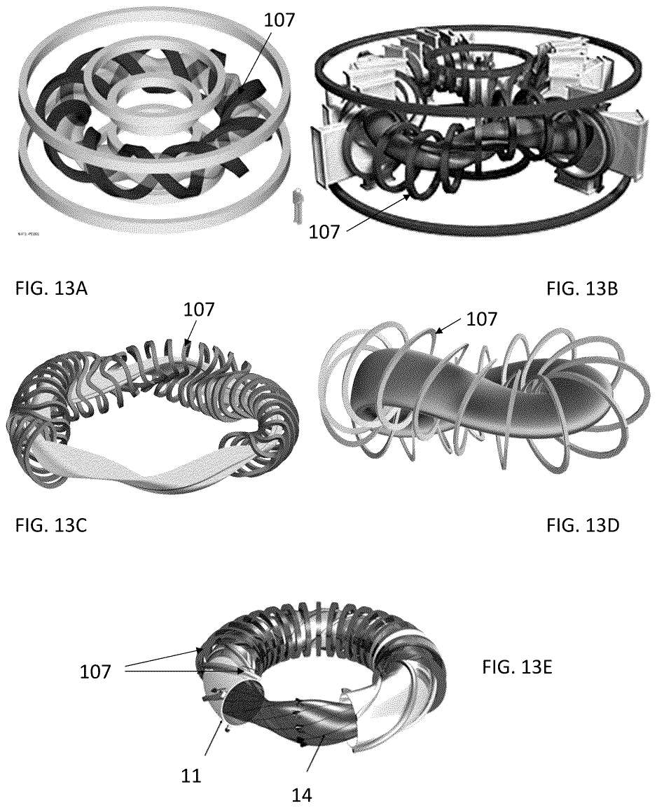

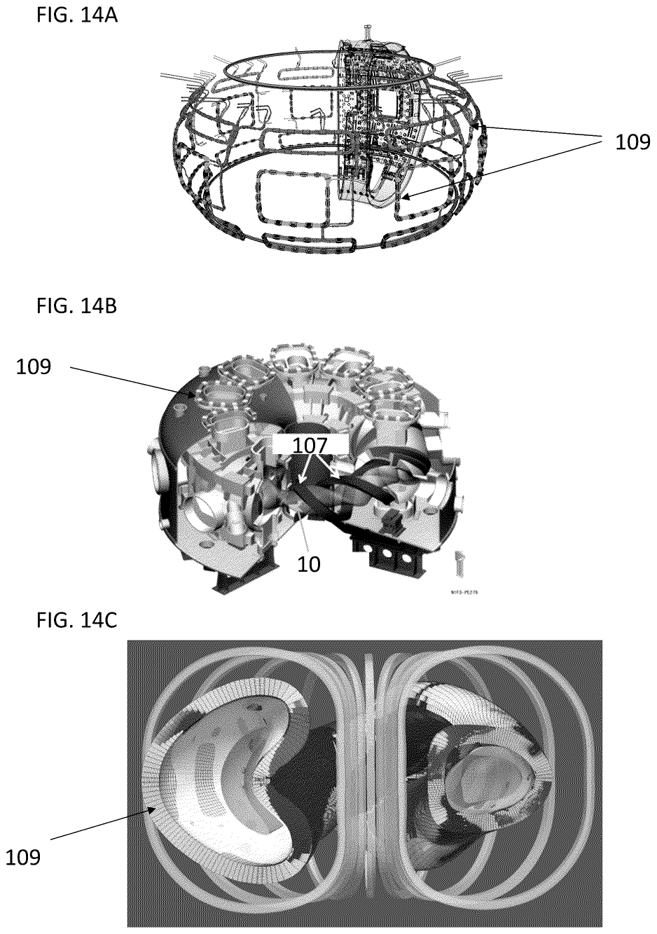

The main magnets 107 can have manner difference shapes including helical coils, non-planar coils and planar coils, and combinations of all of the above, as shown in FIGS. 13A-E. In the case of the control coils 109, FIGS. 14A-C illustrate a conventional tokamak (ITER) and two stellarators.

FIGS. 13A-E illustrate a variety of conventional stellarator-type fusion reactors. All types of stellarators result in a toroidal plasma, which is not symmetrical in the toroidal direction (i.e. is three dimensional). The tokamak on the other hand, with an example shown in FIG. 14A, is an example of a two-dimensional plasma. The stellarator magnetic configuration is formed first in the absence of plasma. The magnetic field lines are configured at least partially by the main magnets 107 so that they travel around the device in the toroidal direction, circumnavigating the device without limit and never reaching the material wall, tracing out a three-dimensional closed magnetic flux surface.

Stellarator designs strive to have large volumes of space in the core occupied with closed magnetic flux surfaces which are nested (like layers of an onion). Nevertheless, there are always regions where the field line does not form such nested magnetic flux surfaces due to the three-dimensional nature of the coils including their imperfections in manufacturing and assembly tolerances. Such field structure is often called stochastic. If this region is towards the periphery of the plasma, then it is possible that as the field line wraps around the device in the toroidal direction that it intersects with the plasma-facing components 1. Such field lines are not able to provide plasma confinement but can be useful in exhausting power and particles from the plasma, such as in the disclosed systems and methods.

All of the above discussion is without plasma present in the system. When gas is added to the vacuum chamber and the volume is heated by one of the standard heating methods (addition of resistive heating, neutral particle beams, ion cyclotron resonance heating, or electron cyclotron resonance heating), a plasma is generated whose density and temperature is determined by the amount of heating power, the amount of gas that has been released into the vacuum chamber and the confinement properties of the magnetic field generated by the external coils.

The plasma density and temperature give rise to a plasma pressure (pressure=density×temperature, where density equals the sum of ion and electron densities). As the magnetic field is designed in the core to confine plasma, the pressure in the center of the plasma will be higher than at the boundary. This plasma pressure gradient in the confinement region (the core) gives rise to 3-dimensional electrical currents flowing in the plasma core according to the equation where ∇p is the pressure gradient, j is the electric current density vector and b is local magnetic field vector:

$$∇ p = j \times b$$

These electrical currents generally tend to enhance the stochastic regions, expanding their domain, particularly at the periphery of the plasma. This depends on the details in a complicated way.

The last closed magnetic flux surface (LCFS) 14, as shown in FIG. 3, is the boundary between closed nested magnetic flux surfaces 30 (which confine plasma by sustaining radial plasma pressure gradients), and the stochastic region (which is not able to confine plasma, i.e. not able to support radial plasma pressure gradients).

As shown in FIG. 4, because of the difference in scales, only a small portion of the plasma core 10 is shown, e.g. the portion close to the boundary, the LCFS 14 and stochastic mantle 12. The values in the FIG. 4 can be deduced by typical values at the LCFS, i.e. a plasma density between 3×10¹⁹ m⁻³ to 5×10²⁰ m⁻³ and a plasma temperature in the range of 30 eV to 1000 eV, and at the plasma facing component with a plasma temperature between 0.1 eV to 30 eV.

Plasma pressure=plasma ion temperature (in units of energy, J)×plasma ion density (m−3)+plasma electron temperature (in units of energy, J)×plasma electron density (m−3). Generally, the ion density is equal to the electron density, and the ion temperature is equal to the electron temperature, hence pressure equals two times the temperature times the density.

Plasma pressure is constant along a magnetic field line in the absence of neutral particles (as in the core and conduction-limited layer). This means that as the plasma temperature decreases in the radial direction in the conduction-limited later, the plasma pressure must rise in the radial direction.

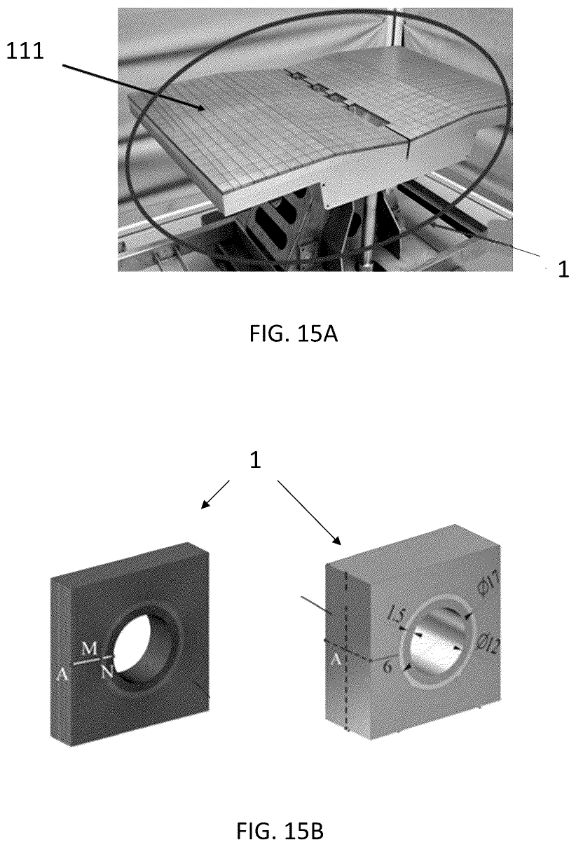

In the dissipative layer 26, neutral particles (atoms and molecules) are present and undergo a large number of different processes in their interaction with the plasma, with the main ones being ionization, molecular dissociation and charge-exchange. The ions that are created then flow along the stochastic fields lines to the plasma facing component where they recombine (either on the surface or in the volume)—this is known as recycling. The presence of neutral particles can give rise to friction on the flowing ions, which reduces the plasma pressure towards the plasma-facing surface 111, as shown in FIGS. 15A and 15B, transferring plasma pressure to the neutral pressure. This is why the plasma pressure decreases in the radial direction in the dissipative layer, while the gas pressure rises all the way to the plasma-facing component of the stellarator of FIGS. 3-4.

The operator can adjust the stellarator vacuum magnetic field including the field in the stochastic mantle 12 by adjusting the control magnets 109, for example by adjusting the current in the electromagnets that make up the control magnets 109, and by adjusting the position and/or orientation of all forms of magnets making up the main magnets 107 and/or control magnets 109 (not all control magnets are electromagnets, some are permanent magnets, others are diamagnets).

For a given vacuum magnetic field, the operator can adjust the temperature and density of the core plasma 10 by adjusting the power injected into the core and the amount of gas released into the vacuum vessel. In the case of an ignited reactor, i.e. where there is no input power and the plasma is sustained only by the power released in the form of the alpha particle (from the DT reaction), then the primary control parameter is the plasma density. Higher density results in high plasma reactivity, and therefore more power released in the core and therefore a higher plasma temperature in the core 10 and at the LCFS 14.

Releasing gas into the plasma chamber also increases the plasma density 24 in the mantle 12, making it opaque for neutral particles, restricting the neutral particles to the dissipative layer 26 and ensuring they do not enter the conduction-limited layer 20, thus ensuring that radial convection of power is small. High plasma density in the conduction-limited layer 20 also ensures that heat flow out of the core plasma 10 results in a temperature gradient along field lines in the mantle plasma portion 12 (in the conduction-limited layer 20), allowing high temperature at the LCFS 14, but low temperature in the dissipative layer 26 and close to the plasma-facing component 1. The low temperature ensures that the energy of ions striking the plasma-facing component 1 are low, thus reducing erosion rates by physical sputtering.

The above-mentioned friction process transfers plasma pressure 23 to gas pressure 27, which has the beneficial effect of reducing the flux of ions to the plasma facing component 1 and elevating the gas pressure 27 at the plasma-facing component 1, and the vicinity of pumping ducts 31, enhancing the rate of removal of the helium ash gas. The helium ash must be removed otherwise its level will build up in the core and dilute the plasma and reduce the reactivity of the fusion fuels (i.e. deuterium and tritium).

The high gas pressure 27 at the plasma-facing component 1 is in the vicinity of the pump ducts 31, see below. These lead to vacuum pumps 32 that can pump both the DT fuel gas and the helium-ash gas. The pumps remove the helium ash from the system and discard it. The DT fuel gas is purified (of the helium and other contaminants) and then re-injected back into the plasma at a different location (not shown) at the plasma-facing component 1.

If the plasma is sustained by power added externally, for a given magnetic field in the core plasma portion 10 and in the stochastic mantle 12, the main control parameter the operator has is the plasma density control through adding gas into the vacuum chamber. The density 24 at the LCFS 14 controls the gas pressure 27 generated at the plasma-facing surface 1, typically the gas pressure 27 increases faster than linear with the plasma density 27 at the LCFS 14.

It is similar in the ignited case, but more complicated by the fact that increased density in the core increases the fusion power crossing the LCFS. Nevertheless, typically the gas pressure increases faster than linear with the plasma density at the LCFS. This can be shown mathematically (See Ref. 1).

The plasma-facing component 1, as shown in FIGS. 15A and 15B, refers to the entire structure whose purpose it is to receive the plasma power. It usually includes water cooling pipes and is made of a high-temperature material, e.g. tungsten with copper tubing (due to its high thermal conductivity) and a stainless structure. See FIG. 15A for an example from the ITER tokamak. The plasma-facing surface 111 is the side of the plasma-facing component 1 that is facing the plasma, so one of the six sides of the plasma-facing component 1, as shown in FIGS. 15A and 15B.

A typical fusion reaction is:

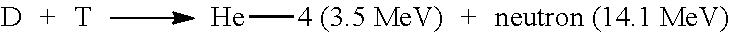

Most of the power comes out in the neutron. Neutrons penetrate deep into materials (>10 cm), depositing their power deep into the blanket 15. A coolant (typically water) removes the heat from the blanket 15 volume.

In the case of the alpha particle (He-4), this provides the plasma self-heating, and can allow the plasma to become ignited (i.e. not requiring an input power to the plasma). The plasma transfers heat to the plasma-facing surface of the plasma-facing component 1. This transfer occurs either through radiative process (electromagnetic radiation which emanates from the plasma across many a broad range of wavelengths) or by the incidence of energetic particles (ions, electrons, atoms and molecules). This heat must be extracted through the plasma-facing surface 111 and is generally much more challenging than taking out the neutron power, as shown in FIGS. 15A and 15B.

Tokamaks and stellarators have traditionally used poloidal divertors, which tend to focus the (alpha) power that comes out of the plasma towards a relatively small area—the divertor strike points (73) on the divertor plate 72. See FIG. 1C.

The stochastic mantle approach distributes the power to (ideally) the entire wall. See FIGS. 12A and 12B.

Previous approaches have used the detached divertor approach in both tokamaks and stellarators. This is effective at locally reducing the temperature of the plasma in contact with the plasma-facing component 1 (in this case the divertor plate 72) at the divertor strike points 73 FIG. 1C.

The rest of the plasma-facing surfaces 111 (>90% of the surface area facing the plasma) are left unprotected in the traditional divertor approach.

The stochastic mantle approach extends the concept of the detached divertor solution to all of the plasma-facing surfaces 111 by utilizing the stochastic magnetic field in the boundary. This ensures that only particles of very low energy can reach any plasma-facing surface 111, thus reducing the erosion at all locations, not just at the divertor plates 72.

In the case of a tokamak, which is nominally axisymmetric in the toroidal direction (two-dimensional), the vacuum magnetic field (i.e. before plasma is induced) has stochastic magnetic field regions 12 that arise due to misalignments or imperfections in the external magnetic coils (which are meant to shape the plasma's magnetic field). These can cause small perturbations or asymmetries in the magnetic field. These small errors can accumulate and cause localized stochastic magnetic field, even in the vacuum magnetic field.

In the case of a stellarator, which is fully three-dimensional, the magnetic field is intentionally twisted and shaped to keep the plasma confined. This twisting often involves non-axisymmetric components (i.e., components that do not respect toroidal symmetry). These non-axisymmetric magnetic fields can create areas where the magnetic field lines no longer follow well-defined, closed or periodic paths. In certain regions, this can result in “chaotic” behavior of the field lines, leading to stochasticity. The degree of stochasticity depends on how the magnetic field is structured, particularly the degree of non-axisymmetry, the strength of various harmonics of the magnetic field, and the plasma parameters.

Both tokamaks and stellarators have additional control magnets, typically smaller than the main coils and which do not link with the toroidal plasma, which may be used to adjust the field in the boundary. These can be used to adjust and control the stochastic filed in the mantle. These often are called RMP (Resonant Magnetic Perturbation) coils, trim coils, or control magnets 109. These concepts are demonstrated in FIGS. 14A-C.

In addition to the influence of the main coils 107 and the control magnets 109, at high plasma pressure, the internal currents flowing inside the plasma influence the stochastic magnetic field, particularly in the case of the stellarator due to its 3-dimensional nature.

In short, the stochastic magnetic field is controlled by a combination of the main magnet 107 coils, smaller control magnets/coils 109 around the periphery of the plasma and the currents flowing in the plasma at high plasma pressure. Detailed three-dimensional calculations are required in order to control and optimize the stochastic magnetic field 201, including account of the external magnets (107 and 109) and currents flowing in the plasma.

The goal is to configure the stochastic magnetic field 201 to be consistent with the following desirable features: i. that plasma power from the core plasma 10 crosses the LCFS 14 and results in uniform power deposition on the plasma-facing surface 111 to the greatest possible extent, i.e. as uniform as possible; ii. that plasma conditions at the LCFS 14 have sufficient collisionality to ensure that plasma power is carried along the stochastic magnetic fields 201 in the stochastic mantle 12 by electron heat conduction 105, and not by convection. This requires at least two conditions are met.

First, the distance along field lines to the plasma-facing surface 111 in the stochastic mantle 12, e.g. adjacent to the LCFS 14, is of sufficient length (L) to be much longer than the electron mean free path. This means that the plasma density 24 at the LCFS 14 for a given power crossing the LCFS 14 must be sufficiently high.

Second, the stochastic mantle 12 is opaque for neutral particles (atoms and molecules) born near the plasma-facing surface 111, i.e. that the ionization mean free path in the radial direction for these neutral particles is sufficient small compared to the radial extent of the stochastic magnetic field 201 to ensure that plasma power is carried from the LCFS 14 to the dissipative layer 26 and/or the plasma-facing surface 111 by electron thermal conduction 105 and not by convection. The presence of conduction ensures that the plasma temperature 21 in the dissipative layer 26 and for the plasma in contact with the plasma-facing surface 111 can be substantially lower than at the LCFS 14. Low plasma temperature ensures low particle energies striking the plasma-facing component 1 and low erosion rates due to physical sputtering. A higher temperature at the LCFS 14 is a base for higher plasma temperature in the core plasma 10, which is better for fusion reactivity in the core.

The last point is the dissipative layer 26, as shown in FIG. 4, which will be guaranteed if the above conditions are satisfied. The dissipative layer 26 is a region close to the plasma-facing surface 111 that contains a mixture of low temperature plasma, atoms and molecules. This is the layer that plasma pressure 23 is transferred to gas pressure 27 by collisions between the plasma ions and the atoms/molecules at low plasma temperature. This is the location by which the high gas pressure, including the contribution from the helium atoms coming from the helium-ash of the fusion reaction, is exploited to extract the gas via pumping ducts 31 to vacuum pumps 32. Extraction of the helium-ash is essential to prevent the core plasma 10 from becoming poisoned by the waste product, helium.

Aside from the neutrons, which directly deposit inside the blanket 15, the fusion power coming from the alpha particles is incident on the plasma-facing component 1 in the form of charged particles, neutral particles and electromagnetic radiation (from many radiative processes in the core plasma 10 and in the stochastic mantle) and removed by active cooling. See FIGS. 12A and 12B.

The stochastic mantle 12 spreads this power uniformly around on all of the surfaces facing the plasma, instead of tending to focus this power at a few specific locations, e.g. at the divertor strike points 73, which is the traditional methodology used in both tokamaks and stellarators (see FIG. 11).

The new method requires arranging the stochastic magnetic field 201, the injected and generated power and plasma density 24 in such a way to ensure that all necessary initial conditions are met for startup and operation of one embodiment of the device of this disclosure.

One of the main goals of the Stochastic Mantle approach is to lengthen the time between maintenance periods (maintenance periods are estimated to last at least 6 months). The main activity during a maintenance period is to replace the plasma-facing components 1, particularly those that have high levels of erosion.

We presently estimate that the time between maintenance periods should increase from 2 years (e.g. in a tokamak without stochastic mantle) to more than 10 years with the Stochastic Mantle approach. This is a substantial improvement, having a big impact of reactor economics and drastically reducing the generation of radioactive waste (remember a discarded plasma facing component 1 is low-level radioactive waste due to neutron activation).

### REFERENCES

1. Pitcher, Charles Spencer, and P. C. Stangeby. “Experimental divertor physics.” Plasma Physics and Controlled Fusion 39, no. 6 (1997): 779.
2. Hayashi, Takaya, Tetsuya Sato, and Akira Takei. Three dimensional studies of helical equilibria and magnetic surface breaking due to the finite beta effect. No. NIFS—7. National Inst. for Fusion Science, 1990.
3. Loizu, Joaquim, S. R. Hudson, C. Nührenberg, J. Geiger, and P. Helander. “Equilibrium β-limits in classical stellarators.” Journal of Plasma Physics 83, no. 6 (2017): 715830601.
4. Suzuki, Yasuhiro, Kiyomasa Watanabe, Hisamichi Funaba, Satrou Sakakibara, Noriyoshi Nakajima, Nobuyoyshi Ohyabu, and LHD Experiment Group. “Effects of the Stochasticity on Transport Properties in High-β LHD.” Plasma and Fusion Research 4 (2009): 036-036.
5. Suzuki, Yasuhiro, K. Ida, K. Kamiya, M. Yoshinuma, S. Sakakibara, K. Y Watanabe, H. Yamada, and LHD Experiment Group. “3D plasma response to the magnetic field structure in the Large Helical Device.” Nuclear Fusion 53, no. 7 (2013): 073045.
6. Suzuki, Y, K. Ida, K. Kamiya, M. Yoshinuma, H. Tsuchiya, S. Inagaki, S. Sakakibara et al. “Investigation of radial electric field in the edge region and magnetic field structure in the Large Helical Device.” Plasma Physics and Controlled Fusion 55, no. 12 (2013): 124042.
7. Suzuki, Y, K. Ida, K. Kamiya, M. Yoshinuma, H. Tsuchiya, M. Kobayashi, G. Kawamura et al. “Impact of magnetic topology on radial electric field profile in the scrape-off layer of the Large Helical Device.” Nuclear Fusion 56, no. 9 (2016): 092002.
8. Suzuki, Yasuhiro. “Effect of pressure profile on stochasticity of magnetic field in a conventional stellarator.” Plasma Physics and Controlled Fusion 62, no. 10 (2020): 104001.
9. Suzuki, Y, K. Y Watanabe, and S. Sakakibara. “Theoretical studies of equilibrium beta limit in LHD plasmas.” Physics of Plasmas 27, no. 10 (2020).
10. Reiman, A., M. C. Zarnstorff, D. Monticello, A. Weller, J. Geiger, and W7-AS Team. “Pressure-induced breaking of equilibrium flux surfaces in the W7AS stellarator.” Nuclear fusion 47, no. 7 (2007): 572.
11. Sharma, Devendra, Yühe Feng, and Francesco Sardei. “3D study of energy transport and role of stochasticity in the W7-X edge.” Plasma physics and controlled fusion 48, no. 1 (2005): 157.
12. Ramasamy, Rohan, Ksenia Aleynikova, Nikita Nikulsin, Florian Hindenlang, Ihor Holod, Erika Strumberger, and Matthias Hölzl. “Nonlinear MHD modeling of soft R limits in W7-AS.” Nuclear Fusion (2024).
13. Reiman, Allan H. “Pressure-driven stochastization of flux surfaces in stellarator equilibria: a review of the experimental observations and their analysis.” Plasma Physics and Controlled Fusion 63, no. 5 (2021): 054002.
14. Pitcher, C. S., A. W. Carlson, C. Fuchs, A. Herrmann, W. Suttrop, J. Schweinzer, M. Weinlich, ASDEX Upgrade Teama, and N. B. I. Groupa. “Routes to divertor detachment in ASDEX Upgrade.” Journal of nuclear materials 241 (1997): 696-700.
15. Pitcher, C. S., C. J. Boswell, J. A. Goetz, B. LaBombard, B. Lipschultz, J. E. Rice, and J. L. Terry. “The effect of divertor baffling on Alcator C-Mod discharges.” Physics of Plasmas 7, no. 5 (2000): 1894-1903.
16. Pitcher, C. S., H-S. Bosch, K. Büchl, A. Field, C. Fuchs, G. Haas, W. Junker et al. “The effect of density on divertor conditions in ASDEX-Upgrade.” Journal of nuclear materials 220 (1995): 213-217.
17. Leonard, A. W. “Plasma detachment in divertor tokamaks.” Plasma Physics and Controlled Fusion 60, no. 4 (2018): 044001.
18. Feng, Yuhe, M. Jakubowski, R. Konig, M. Krychowiak, M. Otte, F. Reimold, D. Reiter et al. “Understanding detachment of the W7-X island divertor.” Nuclear Fusion 61, no. 8 (2021): 086012.
19. Lipschultz, B., B. LaBombard, J. L. Terry, C. Boswell, and I. H. Hutchinson. “Divertor physics research on Alcator C-Mod.” Fusion science and technology 51, no. 3 (2007): 369-389.
20. Krasheninnikov, S. I., A. S. Kukushkin, and A. A. Pshenov. “Divertor plasma detachment.” Physics of Plasmas 23, no. 5 (2016).
21. Loarte, A., R. D. Monk, J. R. Martin-Solis, D. J. Campbell, A. V. Chankin, S. Clement, S. J. Davies et al. “Plasma detachment in JET Mark I divertor experiments.” Nuclear Fusion 38, no. 3 (1998): 331.
22. Matthews, G. F. “Plasma detachment from divertor targets and limiters.” Journal of nuclear materials 220 (1995): 104-116.
23. Soukhanovskii, V. A. “A review of radiative detachment studies in tokamak advanced magnetic divertor configurations.” Plasma Physics and Controlled Fusion 59, no. 6 (2017): 064005.
24. Krasheninnikov, S. I., A. Yu Pigarov, and D. J. Sigmar. “Plasma recombination and divertor detachment.” Physics Letters A 214, no. 5-6 (1996): 285-291.
25. Kolemen, E., S. L. Allen, B. D. Bray, M. E. Fenstermacher, D. A. Humphreys, A. W. Hyatt, C. J. Lasnier et al. “Heat flux management via advanced magnetic divertor configurations and divertor detachment.” Journal of Nuclear Materials 463 (2015): 1186-1190.
26. Neumeyer, C., A. Brooks, L. Bryant, J. Chrzanowski, R. Feder, M. Gomez, P. Heitzenroeder et al. “Design of the ITER in-vessel coils.” Fusion science and technology 60, no. 1 (2011): 95-
27. Encheva, A., H. Omran, A. Devred, A. Vostner, N. Mitchell, N. Mariani, C. H. Jun et al. “Progress on the design development and prototype manufacturing of the ITER in-vessel coils.” Fusion Engineering and Design 124 (2017): 496-500.
28. Ku, Long-Poe, and Allen H. Boozer. “Nonaxisymmetric shaping of tokamaks preserving quasiaxisymmetry.” Physics of Plasmas 16, no. 8 (2009).
29. Zhu, Caoxiang, Michael Zarnstorff, David Gates, and Arthur Brooks. “Designing stellarators using perpendicular permanent magnets.” Nuclear Fusion 60, no. 7 (2020): 076016.
30. Bromberg, L., M. Zarnstorff, O. Meneghini, T. Brown, P. Heitzenroeder, G. H. Neilson, J. V. Minervini, and A. Boozer. “Stellarator configuration improvement using high temperature superconducting monoliths.” Fusion Science and Technology 60, no. 2 (2011): 643-647.
31. Qian, T., M. Zarnstorff, D. Bishop, A. Chamblis, A. Dominguez, C. Pagano, D. Patch, and C. Zhu. “Simpler optimized stellarators using permanent magnets.” Nuclear Fusion 62, no. 8 (2022): 084001.
32. Zarnstorff, M., T. Qian, C. Pagano, D. Bishop, A. Chambliss, A. Dominguez, D. A. Gates, and C. Zhu. “Simpler optimized stellarators using permanent magnets.” In 47th EPS Conf on Plasma Physics, pp. p-P4. 2021.
33. Yang, Y, Y Liang, Y Sun, T. Zhang, J. Pearson, Y Xu, and TEXTOR Team. “Experimental observations of plasma edge magnetic field response to resonant magnetic perturbation on the TEXTOR tokamak.” Nuclear Fusion 52, no. 7 (2012): 074014.
34. Orain, Frangois. “Edge localized mode control by resonant magnetic perturbations in tokamak plasmas.” PhD diss., Aix-Marseille Université; CEA RFM, 2014.
35. Denner, Peter, Y Liang, Y Yang, M. Rack, L. Zeng, J. Pearson, Y Xu, and TEXTOR team. “Local measurements of screening currents driven by applied RMPs on TEXTOR.” Nuclear Fusion 54, no. 6 (2014): 064003.
36. Neubauer, O., G. Czymek, K. H. Finken, B. Giesen, P. W. Hüttemann, H. T. Lambertz, J. Schruff, and TEXTOR team. “The dynamic ergodic divertor in TEXTORA—novel tool for studying magnetic perturbation field effects.” Fusion engineering and design 75 (2005): 495-498.

What is claimed is:

1. A method of generating power from a nuclear fusion reaction, comprising:
providing a magnetic fusion system comprising a fusion chamber including interior plasma facing components, and a plurality of magnets surrounding the exterior of the fusion chamber;
generating a toroidal and poloidal magnetic field having a last closed flux surface (LCFS) and a stochastic magnetic field from the plurality of magnets;
releasing a fusion gas within the fusion chamber;
heating the fusion gas;
generating a core plasma within the fusion chamber from the heated fusion gas confined within the LCFS by the toroidal and poloidal magnetic field;
generating a stochastic mantle plasma within the fusion chamber external to the LCFS, wherein the mantle plasma surrounds the core plasma within the fusion chamber; and
capturing power from the core plasma dispersed widely by the stochastic mantle over the plasma facing components.

2. The method of claim 1, wherein the stochastic mantle plasma comprises a detached condition comprising at least one of a high collisionality condition, an opaque condition, a conduction limited heat transport condition, and one or more dissipative processes.

3. The method of claim 2, wherein the one or more dissipative processes comprises one or more of ionization of particles, dissociation of molecules, molecular radiative processes, bremsstrahlung radiation, charge exchange, and recombination.

4. The method of claim 2, wherein erosion of the plasma facing components is reduced or eliminated due to the detached condition of the stochastic mantle plasma reducing or eliminating sputtering caused by incident particles interacting with the plasma facing components.

5. The method of claim 2, wherein the stochastic mantle plasma comprises a conduction limited portion positioned outside and proximate to the LCFS, wherein at least one of the high collisionality condition, the opaque condition, and the conduction limited heat transport condition are present.

6. The method of claim 5, wherein the stochastic mantle plasma comprises a dissipative portion positioned between the conduction limited portion and the plasma facing components, wherein the one or more dissipative processes are present.

7. The method of claim 1, further comprising generating electrical power by utilizing the captured power from the core plasma to operate a turbine system.

8. The method of claim 1, wherein the captured power is uniformly dispersed over the plasma facing components.

9. The method of claim 1, wherein the magnetic fusion system comprises a stellarator reactor or a toroidal magnetic fusion reactor.

10. A method of forming a plasma having a stochastic mantle in a magnetic fusion system, comprising:
evacuating the fusion chamber via a vacuum system fluidly connected to the fusion chamber;
providing the magnetic fusion system comprising a fusion chamber including an interior plasma facing component, and a plurality of magnets surrounding the exterior of the fusion chamber;
releasing a fusion gas within the fusion chamber;
heating the fusion gas within the fusion chamber to a plasma state;
generating, via the plurality of magnets while accounting for internal plasma magnetic fields cause by currents within the plasma, a magnetic field having a core confinement portion and a mantle stochastic portion, wherein the core confinement portion includes a last closed flux surface (LCFS), and wherein the mantle portion is stochastic and surrounds the core confinement portion within the fusion chamber; and
confining a first portion of the plasma within the core confinement portion and a second portion of the plasma within the mantle stochastic portion, such that the LCFS is between the first plasma portion and the second plasma portion.

11. The method of claim 10, further comprising tuning plasma density of the plasma via at least one of an addition of fusion gas and a removal of fuel gas and the fusion ash product.

12. The method of claim 10, wherein the core confinement portion comprises a toroidal and poloidal magnetic field.

13. The method of claim 10, wherein the magnets comprise one or more of an electromagnet, a permanent magnet, and a diamagnet, wherein the magnetic coils comprise one or more of helical coils, non-planar coils, and planar coils, and wherein a heating system comprises one of resistive heating, a neutral particle beam heater, an ion cyclotron resonance heater, and an electron cyclotron resonance heater.

14. The method of claim 10, wherein the plasma conditions at the last closed flux surface (LCFS) range with a plasma density between 3×10¹⁹ m⁻³ to 5×10²⁰ m⁻³ and a plasma temperature in the range of 30 eV to 1000 eV.

15. The method of claim 10, wherein the plasma conditions at the plasma facing component range with a plasma temperature between 0.1 eV to 30 eV.

16. A magnetic fusion system, comprising:
a toroidal vacuum vessel having an interior plasma-facing component, surrounded by a plurality of external magnets;
a core plasma positioned within the vacuum vessel about a central portion in a toroidal direction; and
a stochastic mantle plasma positioned between the core plasma and the plasma-facing component.

17. The system of claim 16, further comprising a breeder blanket position between the interior plasma facing component and an exterior of the vacuum vessel.

18. The system of claim 17, further comprising a plurality of gas ports passing through the breeder blanket, fluidly connecting the interior of the vacuum vessel to a gas control system.

19. The system of claim 16, further comprising a heating system comprising one or more of resistive heating, a neutral particle beam heater, an ion cyclotron resonance heater, and an electron cyclotron resonance heater.

20. The system of claim 16, wherein the magnets comprise one or more of an electromagnet, a permanent magnet, and a diamagnet, wherein the electromagnets comprise one or more of helical coils, non-planar coils, and planar coils,
